(19) United States
(12) Patent Application Publication
(10) Pub. No.: US 2026/0065098 A1
(43) Pub. Date: Mar. 5, 2026

(54) MACHINE-LEARNED SPECULATIVE DECODING ENGINES

(71) Applicant: Groq, Inc., San Jose, CA (US)

(72) Inventor: Andrew Esper Bitar, Toronto (CA)

(21) Appl. No.: 19/313,459

(22) Filed: Aug. 28, 2025

Related U.S. Application Data
(60) Provisional application No. 63/689,334, filed on Aug. 30, 2024.

(51) Int. Cl. G06N 5/04

(52) U.S. Cl. CPC G06N 5/04

(57) ABSTRACT

The present disclosure provides systems and methods for: obtaining a request; obtaining, from a draft model, a first plurality of draft tokens based on the request; determining an error rate associated with the first plurality of draft tokens; determining a modified context length for the draft model based on the error rate; and configuring the draft model based on the modified context length.

### CROSS REFERENCE TO PRIORITY APPLICATIONS

The present application claims priority to U.S. Provisional Ser. No. 63/689,334, filed Aug. 30, 2024, the entirety of which is incorporated by reference herein.

### FIELD

The present disclosure relates generally to processors utilized in machine-learning applications, such as processors for processing tensors. More particularly, the present disclosure relates to machine-learned speculative decoding engines.

### BACKGROUND

Machine learning is an artificial intelligence technique in which a computing device can “learn” from training data, such as training data obtained from a static training dataset or an interactive learning environment. For example, a computing system can obtain a training dataset; initialize a machine learning model comprising a plurality of parameters (e.g., untrained parameters such as randomly generated starting parameters, etc.); and train the parameters based on the training dataset. The trained machine-learned model can then be used to perform various operations, such as prediction operations, generative artificial intelligence operations (e.g., language generation, image generation, audio generation, video generation, etc.), automation operations (e.g., hardware automation such as robot or automobile automation, software automation such as web browser or user interface automation, etc.), reasoning operations, agentic operations, or other machine learning operations. Operations performed by a trained machine-learned model can be referred to as machine-learned inference operations.

### SUMMARY

Aspects and advantages of embodiments of the present disclosure will be set forth in part in the following description, or can be learned from the description, or can be learned through practice of the embodiments.

In an aspect, the present disclosure relates to a method. The method includes obtaining a request. The method includes obtaining, from a draft model, a first plurality of draft tokens based on the request. The method includes determining an error rate associated with the first plurality of draft tokens. The method includes determining a modified context length for the draft model based on the error rate. The method includes configuring the draft model based on the modified context length.

In another aspect, the present disclosure relates to a system. The system includes one or more processors and one or more non-transitory, computer-readable media storing instructions that, when implemented, cause the one or more processors to perform operations. The operations include obtaining a request. The operations include obtaining, from a draft model, a first plurality of draft tokens based on the request. The operations include determining an error rate associated with the first plurality of draft tokens. The operations include determining a modified context length for the draft model based on the error rate. The operations include configuring the draft model based on the modified context length.

In another aspect, the present disclosure relates to one or more non-transitory, computer-readable media storing instructions that, when implemented, cause one or more processors to perform operations. The operations include obtaining a request. The operations include obtaining, from a draft model, a first plurality of draft tokens based on the request. The operations include determining an error rate associated with the first plurality of draft tokens. The operations include determining a modified context length for the draft model based on the error rate. The operations include configuring the draft model based on the modified context length.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a diagram of a system according to example aspects of the present disclosure;

FIG. 2 illustrates a diagram of a system according to example aspects of the present disclosure;

FIG. 3 illustrates a flowchart diagram of a method according to example aspects of the present disclosure;

FIG. 4 is a block diagram of an example processor device according to example implementations of aspects of the present disclosure;

FIG. 5 is a block diagram of an example multi-node computing system according to example implementations of aspects of the present disclosure;

FIG. 6 is a block diagram of an example system for compiling a machine-learned model according to example implementations of aspects of the present disclosure;

FIG. 7 is a block diagram of an example system for compiling a machine-learned model according to example implementations of aspects of the present disclosure; and

FIG. 8 is a block diagram of an example system for performing machine-learned inference according to example implementations of aspects of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

Large language models (LLMs) are used in generative artificial intelligence applications for a variety of purposes, such as for programming assistants, chatbots, etc. LLMs are at the center of the recent rapid progress in artificial intelligence (AI). In some LLMs, transformer models may generate words (tokens) based on a prompt and based on previously generated words (tokens) providing context. Furthermore, some transformer models process input data sequentially, generating output tokens one at a time. While groundbreaking, a challenge for user-facing products is that due to their size, these large models can be slow at inference (i.e., output generation), which may result in an undesirably slow user experience and/or can require significant amounts of memory to store, which may limit their applicability to resource-constrained devices. This latency can arise from the token-by-token generation in part due to autoregressive decoding, resulting in an escalation of the inference latency with both the length of the generated sequence and the model's scale.

For instance, for a given input, some large language models may generate an output through a process involving processing input data, understanding context associated with the input data, and generating a relevant and coherent response. This process can become increasingly demanding for long-range dependencies, such as those where the model is to consider a significant portion or even the entirety of the input data when generating each output token. These models can additionally be sensitive to hallucinations, where the model generates text that is not present in the training data and/or not responsive to the input prompt. These hallucinations can result in inappropriate and/or incorrect responses, which can be problematic in applications where accuracy and relevance are desirable. These challenges can, in some instances, contribute to significant waste of computing resources, power, and/or time. For example, processing long input sequences including hallucinations can involve substantial waste computing resources and time. Furthermore, these challenges can limit the deployment of LLMs on resource-constrained devices, such as smartphones or embedded devices, which can hinder their adoption in various applications. Addressing these challenges can therefore provide for more efficient, accurate, and/or accessible machine-learning systems for a variety of applications.

An emerging inference paradigm referred to as speculative decoding provides reduced latency in some instances. Speculative decoding involves the parallel generation of drafted tokens as a speculation of future decoding steps of the target LLM. The target LLM can then be used to verify each drafted token in parallel. Tokens that are successfully verified can be accepted and included in the output of the LLM. In some example implementations, a speculative decoding system can accelerate large model inference by leveraging a combination of one or more relatively smaller “draft model(s)” and a relatively larger “target model” (which may also be referred to as an “oracle model”). The draft model(s) generate “guess tokens” at a faster rate, while the target model verifies these guesses in parallel, resulting in higher speed and throughput. One example system includes a single draft model and a single target model. Another example system can include a single target model and multiple draft models, each having its own controller to achieve the overall inference target.

Speculative decoding can improve the applicability of LLM inference. As one example, many easy tokens can be predicted with less computational overhead, so easier tokens may be allocated to a less resource intensive (e.g., smaller) draft model whereas more challenging tokens may instead be allocated to a more resource intensive (e.g., larger) draft model that is consequently more powerful. As another example, LLM inference may generally be memory bandwidth bound, where the primary bottleneck in generating outputs can arise from storing and/or retrieving data to/from memory. For instance, in some cases, computations and compute cycles may be relatively more available than memory bandwidth. Some hardware tailored to machine-learning, such as tensor streaming processors, may generally be highly parallelized and capable of orders of magnitudes more operations per second than memory bandwidth. By focusing the LLM's computational efforts on validating pre-drafted tokens rather than generating the tokens themselves, speculative decoding can reduce the frequency of memory operations on LLM parameters and in some cases improve the efficiency of inference operations, such as in cases where speculative decoding is performed using hardware tailored to machine-learning, such as tensor streaming processors.

Furthermore, according to example aspects of the present disclosure, a speculative decoding system can have improved throughput. According to example aspects of the present disclosure, the draft model(s) can be run on a reduced context window, thereby increasing the throughput of the draft models. This increased throughout can be achieved even if an error rate of the speculated tokens is increased. Furthermore, according to example aspects of the present disclosure, a sliding-window attention provides that stored context for the draft models is limited to a number of most recently generated tokens. The size of the sliding-window attention (e.g., the number of tokens stored in the context) can be dynamically adjusted during token generation based on the present error rate of the draft model(s). For instance, the present disclosure can provide for increasing or decreasing a number of tokens in the context of a draft model based on a corresponding increase or decrease in the error rate of generated tokens from the draft model.

Intuitively, the context length presents a trade-off for the speculative decoding system. A shorter context can involve relatively fewer computing resources to fully process than a longer context, but may also encode less information for the draft model to use in generating tokens, thereby causing a greater error rate of the generated tokens. However, as the context becomes longer, the relationship between generated tokens and tokens at the beginning of the context can be weaker. Thus, omitting tokens from the beginning of the context may slightly increase an error rate of the draft model, but may significantly increase the throughput of the draft model by an amount that more than compensates for the increased error rate. For example, the overall throughput of the system, as a function of generated and verified tokens, may be greater even when accounting for the increase in regenerated tokens. Additionally, because the tokens are verified at the target model, the occasional erroneous token due to the shortened context length ideally does not pass to the final output of the system. If, however, the error rate increases too greatly, the regeneration of erroneous tokens may have an overly detrimental effect on the throughput of the speculative decoding engine, and the context length may instead be increased to reduce the error rate.

Aspects of the present disclosure provide a number of technical effects and benefits, including improvements to the computing-technology-related field of machine-learning, and in particular content or token generation responsive to a user prompt. In particular, providing a sliding attention window that is dynamically adjusted based on an error rate determined with respect to generated tokens from a draft model can provide a number of benefits to optimizing a trade-off between throughput of the generated tokens and accuracy of the generated tokens. This trade-off can be optimized to increase the throughput of the speculative decoding system as a whole. In addition, the increased throughput of the speculative decoding system as a whole can provide for reduced computing resource utilization, reduced computing time, and/or reduced energy utilization in generating responses to user prompts relative to conventional approaches, without a corresponding decrease in other metrics such as accuracy.

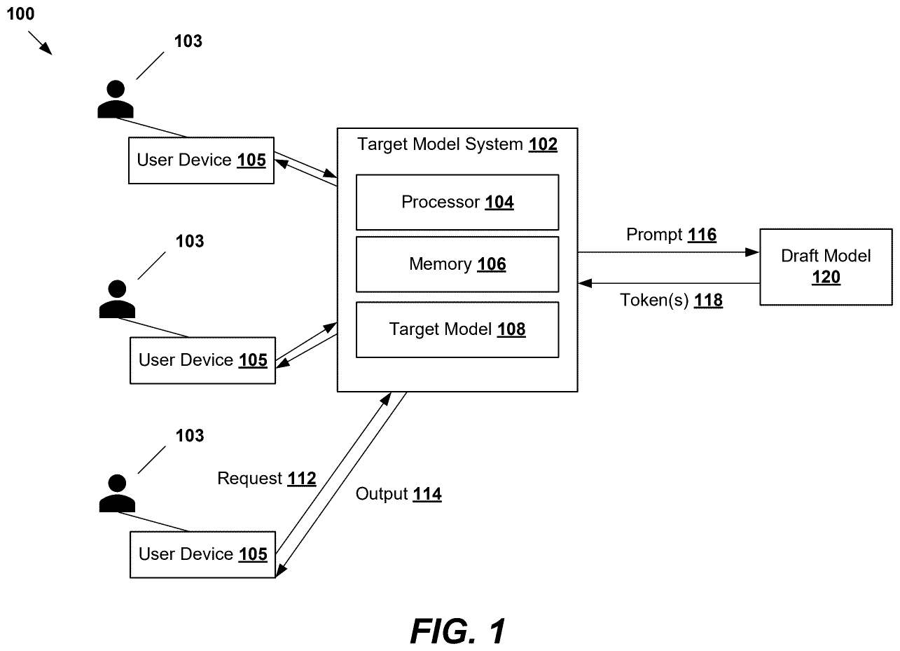

FIG. 1 depicts a speculative decoding system 100 according to example aspects of the present disclosure. According to example aspects of the present disclosure, the speculative decoding system 100 can improve the efficiency of token generation while maintaining accuracy and/or minimizing hallucinations. The speculative decoding system 100 includes a target model system 102. The target model system 102 can be a computing system, such as a server computing system, datacenter, or other suitable computing system. For instance, the target model system 102 can include a processor 104 and a memory 106. The memory 106 can store computer-readable instructions that, when implemented by the processor 104, cause the processor 104 to perform the operations described herein.

The speculative decoding system 100 can further include a target model 108. The target model 108 can receive requests 112 from user(s) 103 via user device(s) 105. The requests 112 can ask the target model 108 to generate an output or otherwise perform a task relative to the requests. For example, a request 112 may include a phrase of tokens in a plain language, and the users 103 may generally expect an output from the target model 108 that is responsive to the phrase in the request. The target model 108 can generate an output 114 including a plurality of tokens. In some implementations, the target model 108 can be a large language model, such as an LLM including one or more transformer models. Example LLMs include, but are not limited to, GPT-3, GPT-4, GPT-5, Gemini, Falcon, Claude, Cohere, LLAMA (e.g., LLAMA 70B), BERT, DeepSeek, PaLM, Orca, LaMDA, Mistral, and various others.

According to example aspects of the present disclosure, the target model 108 can interface with one or more draft models 120 to generate its output. The draft model 120 can receive a prompt 116 from the target model 108 and, responsive to the prompt 116, generate a series of tokens 118 (also referred to as “draft tokens” prior to verification by the target model 108) that are intended to produce the output 114 corresponding to the assigned request 112. At each decoding step, the target model 108 can obtain draft tokens 118 from the draft model 120. In some implementations, at each decoding step, a draft model 120 may draft one draft token 118. In some implementations, a draft model 120 may generate multiple draft tokens 118 per decoding step. The number of draft tokens 118 generated at each decoding step can be scaled to modify the throughput (e.g., the overall throughput) of the system 100.

The target model 108 can verify the draft tokens 118 from the draft model 120 for inclusion in its output 114. The target model 108 can, in some implementations, verify multiple tokens 118 in parallel. Thus, in some implementations, the throughput of the draft model 120 can be coordinated with the time required to verify a batch of tokens 118 at the target model to provide an ideal throughput of the system (which may not necessarily be achievable in practice). The target model 108 may also reject a token 118 from the draft model 120. If a token is rejected, the target model 108 may reset to the context of the last accepted token and restart the concurrent generation at the last accepted token, continuing with this process until the output 114 is completed (e.g., if an end-of-response token is predicted). In this manner, the target model 108 may be dedicated to verification of tokens 118 rather than generation of tokens 118. This can provide for efficient processing of multiple tokens 118 while maintaining accuracy. In some implementations, if an erroneous draft token is recognized and rejected, the target model 108 can generate a revised prompt 116 and resubmit the revised prompt to the draft model 120 to cause the draft model 120 to regenerate the draft tokens 118.

As used herein, references to the target model 108 processing tokens 118 in “parallel” refers to simultaneous or concurrent processing of multiple tokens 118 in a single “batch” or group, as opposed to processing the tokens sequentially, one at a time. This provides for the target model 108 to generate the output 114 faster and more efficiently compared to sequential generation and verification. In general, processing tokens 118 in parallel can be useful for tasks such as language translation, text summarization, and language generation, where the model 108 is to process long sequences of text. By processing multiple tokens 118 in parallel, the system 100 can generate text faster and more efficiently, while still ensuring accuracy and minimizing the potential for errors. Advantageously, parallel token processing further reduces power consumption compared to legacy models.

In the example of FIG. 1, a single draft model 120 is illustrated. In some implementations, more than one draft model 120 can interface with the target model 108. For instance, the target model 108 can orchestrate concurrent generation tasks across a plurality of draft models 120. As one example, each request 112 (e.g., from each user device 105) may be assigned to one of the draft models 120. For instance, a plurality of users 103 can share the verification capacity of the target model 108 while the generation capacity is delegated to the lighter-weight draft model(s) 120.

The draft models 120 may be or may include transformer models, such as non-autoregressive transformer models. Furthermore, in some implementations, a variety of model types or model configurations can be used for draft models 120. For example, in some implementations, different draft models 120 may have differing complexities, such as differing numbers of layers, differing parameter values, differing model architectures, or other suitable variations.

In one example implementation, the target model 108 is a relatively larger LLM such as a LLAMA 70B model, a GPT-4 1.8T parameter model, or a JAIS 180B parameter model, whereas the draft model 120 is a relatively smaller model such as a Mistral 7B model or Mistral 8×7B model. These example models are provided for the purpose of illustration, and are not otherwise intended to limit any aspect of the present disclosure. Generally, it is understood that the number of parameters of a given machine-learned model quantify the size and, to some extent, the accuracy of the model, although a larger model size is not necessarily always correlated to greater accuracy.

In some implementations, the target model 108 may also initiate a refill request. The refill request may be performed before any additional verifications. In response to the refill request, the target model system 102 can reset to the point where the last accepted token was accepted, discarding any “incorrect” tokens that came afterward.

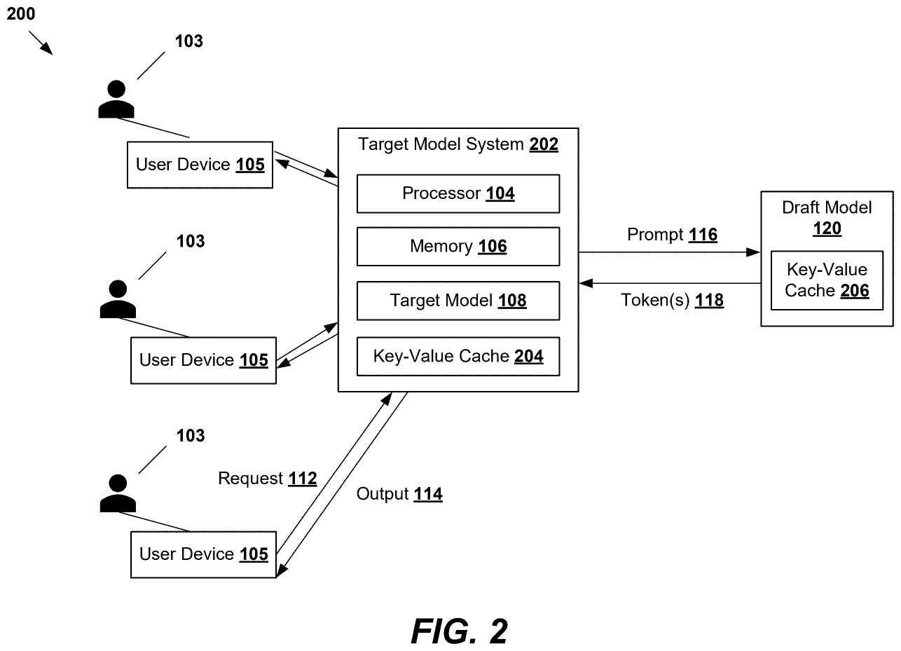

FIG. 2 depicts a block diagram of another speculative decoding system 200. The speculative decoding system 200 is similar to the speculative decoding system 100 of FIG. 1. Like reference numbers used in FIG. 2 depict components that are similar to those described with respect to FIG. 1, except where otherwise indicated. In particular, the target model system 202 of FIG. 2 (e.g., the target model 108) includes, or is otherwise configured to interface with, a key-value (KV) cache 204. Additionally and/or alternatively, the draft model 120 includes, or is otherwise configured to interface with, a KV cache 206. A KV cache refers to a data structure used by machine-learned models to store frequently accessed data in memory for quick retrieval. For instance, transformer models may use a key-value cache to avoid redundant computations by storing the intermediate results of a self-attention mechanism, namely the key and value vectors, computed during the forward pass for each processed input token. When processing subsequent tokens, the model retrieves and reuses these cached key-value pairs, allowing the model to compute the self-attention for new tokens without recalculating the attention for previously processed tokens.

The size of a KV cache may be related to the size of the machine-learned model. For instance, in some implementations, the KV cache 204 of the target model 108 may be relatively larger than the KV cache 206 of the draft model 120. A larger KV cache can store more data, which may improve throughput of the model. However, the size of the KV cache may also impact the time involved for processing. For instance, a larger KV cache can take a greater amount of time to traverse, especially for models with increasingly larger numbers of parameters, thereby increasing the time involved in processing tokens. It is noted that the size of the KV cache is not the only factor that affects the performance of a machine-learned model. Other factors, such as the architecture of the model, and the computational resources available, can also have an impact on the model's performance. Thus, in some cases, the size of the KV cache(s) 204, 206 may provide a limiting factor on throughput of the target model 108 and/or the draft model 120.

Returning to the description of the draft model 120 as described with reference to either or both of FIGS. 1 and 2, the context length (which may also be referred to as “context window” or “context size”) can be dynamically adjusted during token generation based on an error rate of the draft tokens 118. The phrase “context length” refers to the number of tokens or words that a model can process and retain in its working memory before processing the next token. For instance, a smaller context size for the draft model 120 can reduce processing time, while a larger context size may result in improved accuracy. Adjusting the context size thereby presents a trade-off or compromise between precision, efficiency, and low latency. The trade-off between the context size of the draft model 120, the error rate, and processing time is recognizable according to example aspects of the present disclosure. For instance, a larger context size may be desirable for tasks that call for a deeper comprehension of the input, whereas a smaller context size may be acceptable for jobs that do not. Many tokens do not need the entire context history in order to be predicted. Generally, the present inventors have observed that a token is more immediately dependent on the most recent prior tokens rather than the earliest prior tokens. Therefore, the error rate is expected to increase sub-linearly as the context window is shrunk.

For instance, in some implementations (e.g., under typical circumstances), the draft model 120 and the target model 108 can use a common context length. However, in some implementations, the context length of the draft model 120 can be adjusted to modify (e.g., increase or decrease) the number of tokens 118 generated by the draft model 120 prior to those tokens 118 being verified by the target model 108. The throughput of the draft model 120 may therefore be limited by the size of the KV cache 206. For instance, as the context length is increased, the peak throughput of the draft model 120 can be reduced due at least in part to longer cache load time, a longer attention mechanism, and/or a reduced number of caches that fit within the memory capacity allocated to the KV cache 206.

According to example aspects of the present disclosure, the draft model 120 can be provided with a relatively smaller context window (e.g., compared to the target model 108 and/or compared to a default condition of the draft model 120) to increase the throughput of the draft model 120, irrespective of a resulting increase in error rate for the draft tokens 118. A “sliding-window attention” provides that the stored context maintains the most recent tokens and dynamically adjusting the size of the context window of the draft model 120 based on the dynamically tracked error rate. Intuitively, as the context becomes longer, the relationship between newly-generated tokens and tokens at the beginning of the context becomes weaker. Therefore, the decrease in overall throughput attributable to the increased error rate will reduce the throughput (e.g., attributable to regenerating erroneous tokens) can be less than the increase in throughput attributable to the reduction in processing time to generate new tokens, resulting in a net improvement in achieved throughput.

The present disclosure further provides for dynamic adjustment of the speculation distance (e.g., to balance throughput and accuracy). For instance, the dynamic sizing of the context window of the draft model 120 can provide for dynamic adjustment of the speculation distance of context size. The speculation distance refers to the distance between the generated tokens 118 from the draft model 120 and the tokens that have been verified by the target model 108. For instance, the speculation distance can be the distance between the point where the draft model 120 begins generating new tokens 118 and the point where the target model 108 verifies the correctness of those tokens. Intuitively, speculation distance can be the distance that the draft model 120 is allowed to “speculate” or generate new tokens before the target model 108 verifies the correctness of those tokens.

The speculation distance can be adjusted to balance throughput and accuracy while the prompt 116 is being processed. For instance, by adjusting the speculation distance, the system can dynamically balance the trade-off between processing time and accuracy. A larger speculation distance can provide for faster processing times, but may result in a higher error rate, while a smaller speculation distance can provide higher accuracy but may increase processing time. By adjusting this distance, the system can optimize the balance between processing speed and accuracy based on the specific requirements of the task and the capabilities of the models.

In some implementations, the context length may be modified during an inference task. For example, while generating an output, the context length may be dynamically resized to provide efficient generation of that output. Additionally and/or alternatively, in some implementations, the context length may be static (e.g., unmodified) for one or more inference tasks, but may be modified after completing execution of the one or more inference tasks. For instance, the speculative decoding system(s) 100, 200 may provide for maintaining a consistent context length until an output is generated, and may refine the context length for generating the next output more efficiently. Still further, in some implementations, the context length may be static across all inference tasks. For example, the context length may not be dynamically adjusted, but instead may be maintained at a consistent value for the target model 108 and/or the draft model 120. For instance, the context length of the draft model 120 may be maintained at a value that is significantly smaller than the context length of the target model 108. This, in turn, can provide for improved generation efficiency of tokens from the draft model 120 while, due at least in part to the larger context length used in verification by the target model 108, can provide for maintaining the accuracy available from a larger context length.

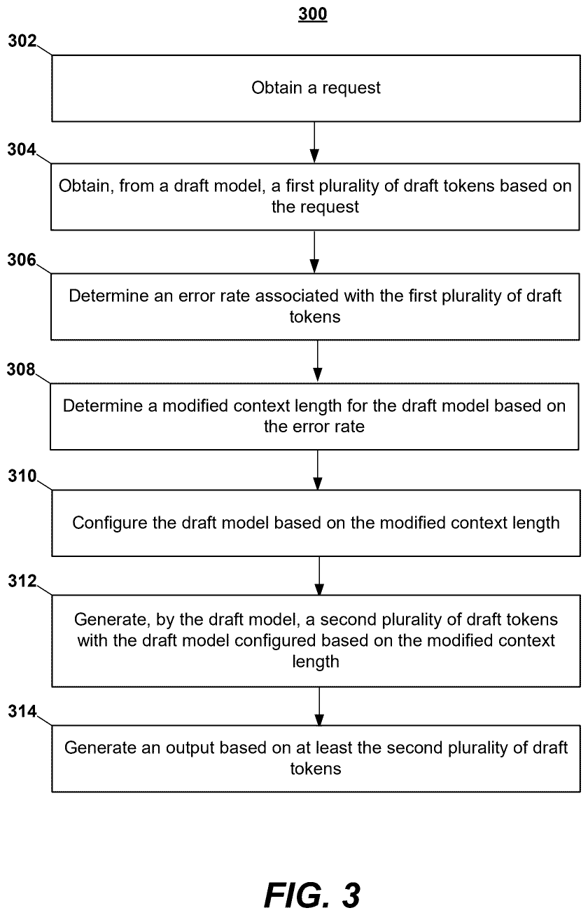

FIG. 3 illustrates a flowchart diagram of a method 300 according to example aspects of the present disclosure. One or more portion(s) of the method 300 can be implemented by a computing system that includes one or more computing devices such as, for example, the computing systems described with reference to the other figures (e.g., system 100, system 200, etc.). Each respective portion of the method 300 can be performed by any (or any combination) of one or more computing devices. Moreover, one or more portion(s) of the method 300 can be implemented on the hardware components of the device(s) described herein (e.g., as in FIGS. 1-2, 4-8, etc.), for example, to validate one or more systems or models. FIG. 3 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 3 is described with reference to elements/terms described with respect to other systems and figures for exemplary illustrated purposes and is not meant to be limiting. One or more portions of method 300 can be performed additionally, or alternatively, by other systems.

The method 300 can include, at 302, obtaining a request. The request, for instance, can be obtained from a requestor device, such as a user computing device (e.g., via a user), another computing system, or any other suitable entity capable of providing a request. The request can instruct a machine-learned model (e.g., an LLM) to generate an output responsive to the request. For example, the request can instruct a machine-learned model to perform a task, such as a content generation task, an information retrieval task, or other suitable task. The request can, for example, be used as input data to the machine-learned model to seed the machine-learned model in generating an output responsive to the request. The request may additionally and/or alternatively be referred to as a “prompt” or “input prompt.” The request can be or can include any suitable data, including, but not limited to, text data, image data, audio data, video data, or other suitable data. In some implementations, the request may be a plain language text prompt or other suitable plain language data.

The method 300 can include, at 304, obtaining a plurality of draft tokens based on the request. The plurality of draft tokens can be obtained from a draft model, such as the draft model 120 of FIG. 1. For instance, in some implementations, the request can be provided to one or more draft models tasked with generating a plurality of tokens to perform the task (e.g., a content generation task) specified by the request. In some implementations, the request may be provided to a target model, such as the target model 108 of FIG. 1. The target model may generate a draft prompt based on the request to instruct the draft model to generate the plurality of draft tokens. The target model can provide the draft prompt to the draft model to cause the draft model to generate and provide the plurality of draft tokens for validation by the target model. At 304, the draft model may be configured for a first value for a context length of the draft model. For instance, the first value for the context length can be an initial context length. The initial context length can be selected based on, for example, a default context length of the system. As another example, the initial context length can be an earlier-determined context length (e.g., from a previous iteration of the method 300). As another example, the initial context length can be selected based on the context length of the target model. For instance, the initial context length of the draft model may be equivalent to or identical to the context length of the target model and/or may be smaller than the context length of the target model. In some implementations, for example, the initial context length may be a relatively small context length (e.g., on the order of less than 100 tokens) and may be increased only when the utilized context exceeds this smaller context length and/or an error rate exceeds some acceptable bounds.

The method 300 can include, at 306, determining an error rate associated with the plurality of draft tokens. As one example, the error rate can be a ratio or other suitable representation that relates a number of draft tokens that are successfully validated (referred to as “validated tokens” or “verified tokens”), a number of draft tokens that are rejected (referred to as “rejected tokens” or “erroneous tokens”), and/or a total number of draft tokens. As one example, the error rate can be a ratio or percentage of rejected tokens to total tokens. As another example, the error rate can be a ratio or percentage of validated tokens to total tokens. As yet another example, the error rate can be a ratio or percentage of rejected tokens to validated tokens. The validated tokens and/or rejected tokens can be determined by the target model and/or a system hosting the target model, such as the target model system 102 of FIG. 1. The error rate can be affected by a context length of the draft model. For instance, as recognized according to example aspects of the present disclosure, the error rate (e.g., the number of rejected tokens) may correspond (e.g., inversely correspond) to the context length of the draft model. For instance, an increase in context length may contribute to a decrease in the error rate. It should be understood that while reducing the error rate can be beneficial to the systems and methods described herein, a nonzero error rate is not necessarily detrimental to the systems and methods described herein, as mechanisms can be provided to regenerate rejected tokens. Therefore, it may be beneficial for some systems and methods described herein to optimize for a factor other than error rate, such as, for example, overall throughput, overall latency, or other suitable metrics.

The method 300 can include, at 308, determining a modified context length for the draft model based on the error rate. As described herein, the modified context length can be selected to optimize for a target metric of the system. The system can measure a corresponding current metric and, based on a comparison between the target metric and the current metric, the system can determine to increase or to decrease the modified context length (e.g., relative to a current context length of the draft model). As one example, the system can be provided with a target overall throughput. The system can determine that a current overall throughput is less than the target overall throughput and determine to increase or to decrease the context length of the draft model. The system can further determine whether to increase or to decrease the context length of the draft model based on a data trend associated with the current metric. For example, this approach can be repeated iteratively, where if a previous change in one direction negatively affected the metric, a change in another direction is made subsequent to the previous change.

The method 300 can include, at 310, configuring the draft model based on the modified context length. For example, configuring the draft model based on the modified context length can include causing the draft model to consume a context having a length equal to the modified context length. This can be accomplished in a number of manners, including, for instance, modifying a buffer size associated with the context, modifying a size of a key-value cache associated with the draft model, truncating a data structure comprising the context of the draft model, or any other suitable manner. For instance in some example implementations, configuring the draft model based on a modified context length can include adjusting a size of a key-value cache accessed by the draft model. In some implementations, the steps of method 300, such as, for example, obtaining the request (e.g., at 302), obtaining the first plurality of draft tokens (e.g., at 304), and configuring the draft model based on the modified context length (e.g., at 310), and/or the other steps described herein, can be performed for a single inference task. For instance, the context length may be modified during generation of a single output. Additionally and/or alternatively, in some implementations, the context length may be modified only after generation of the output is complete, to provide for more efficient generation of a following output (e.g., for a following inference task).

The method 300 can include, at 312, generating, by the draft model, a second plurality of draft tokens with the draft model configured based on the modified context length. For instance, subsequent to configuring the draft model based on the modified context length, the draft model can generate new draft tokens responsive to a new context having the modified context length. If the modification is performed during a generation task, for instance, the new context may include some portion (e.g., a lesser or greater portion) of an overall context than a previous context length, depending on the change in context length.

In some implementations, steps 304 to 312 can be iteratively repeated to optimize the context length of the draft model over one or more iterations. For example, the second plurality of draft tokens can be used as the first plurality of draft tokens in a second iteration, and an error rate can be determined for the second plurality of draft tokens, used to determine a modified context length, and so on. In this manner, the context length can be dynamically adjusted during a speculative decoding operation to provide improved throughput and/or latency for the system.

The method 300 can include, at 314, generating an output based on at least the second plurality of draft tokens. For instance, the second plurality of draft tokens can be combined with additional draft tokens (e.g., from the first plurality of draft tokens and/or other generation batches) of the draft model and/or additional draft models, in embodiments having a generation task divided among a plurality of draft models. The output can be, for example, a response to the request. For instance, the output can provide content requested by the request, such as generated content or retrieved content. Additionally and/or alternatively, the output can inform a user of successful or unsuccessful performance of a task specified by the request. The output can be or can include, for example, plain language data (e.g., text data) intended for reading by a human user and/or computer-readable data such as object data, image data, video data, and/or other suitable data.

Example aspects of the present disclosure may be implemented using one or more processors, such as tensor streaming processors, FPGAs, ASICS, etc. An example tensor streaming processor will be discussed in detail below for purposes of illustration and discussion. However, those of ordinary skill in the art, using the disclosures provided herein, will understand that aspects of the present disclosure may be implemented using any suitable processor, processing circuitry, or the like without deviating from the scope of the present disclosure.

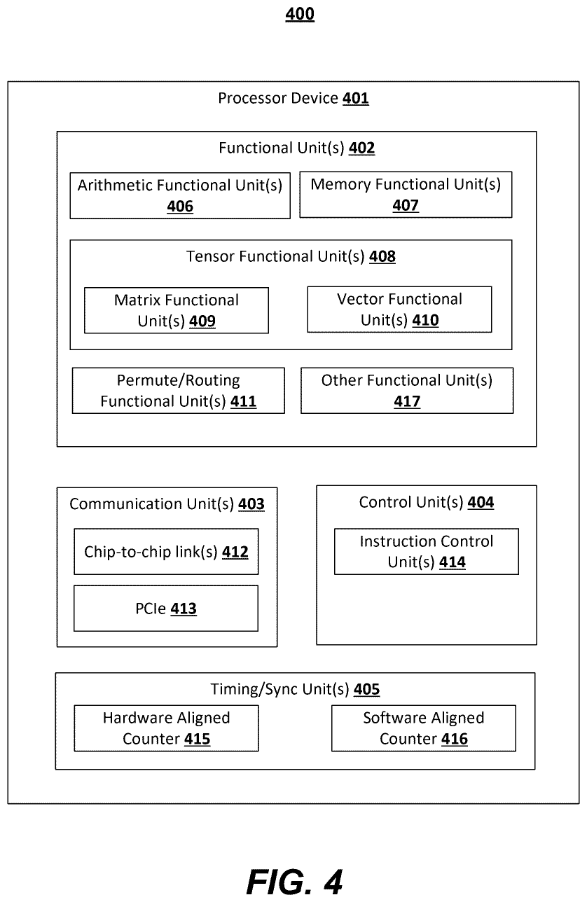

FIG. 4 is a block diagram of an example system 400 including a processor device 401 according to example implementations of aspects of the present disclosure. The processor device 401 can include one or more functional units 402; one or more communication units 403; one or more control units 404 (e.g., instruction control unit(s) 414, etc.); one or more timing or synchronization units 405; or other components. In some instances, functional unit(s) 402 of the processor device 401 can include one or more of: arithmetic functional unit(s) 406; memory functional unit(s) 407; tensor functional unit(s) 408 (e.g., matrix functional unit(s) 409, vector functional unit(s) 410, etc.), permute or routing functional units 411, or other functional units 417. Communication unit(s) 403 can include, for example, one or more of chip-to-chip communication link(s) 412, peripheral component interconnect express 413 components, or other communication unit(s) 403. Timing and synchronization units 405 can include, for example, one or more hardware-aligned counters 415, one or more software-aligned counters 416, or other timing or synchronization component.

A processor device 401 can include various types of processor architectures. In some instances, a processor device 401 can include a single-core or multi-core processor device 401. In some instances, a processor device 401 can include an integrated circuit located on a single die or a processor device 401 distributed over multiple dies connected together (e.g., directly connected such as via face-to-face connection, indirectly connected such as via one or more interposers, etc.). In some instances, a processor device 401 can include one or more of: one or more field-programmable gate arrays (FPGAs); one or more application-specific integrated circuits (ASICs), such as ASICs for machine-learned inference, matrix multiplication, floating-point operations, or the like; one or more graphics processor units (GPUs); one or more tensor processing devices; or other processor type. In some instances, a processor device 401 can include a deterministic processor device or a non-deterministic processor device (e.g., processor device configured to operate according to a deterministic or non-deterministic timing, etc.). In some instances, a processor device 401 can include a processor device having a plurality of dedicated special-purpose functional units, or a processor device having one or more general-purpose functional units (e.g., multi-core processor having a plurality of general-purpose processor cores, etc.). For example, in some instances, a processor device 401 can include a single-core processor device 401 having a plurality of special-purpose functional units 402 having distinct functions, such as functional units 402 having distinct instruction set architectures.

In some instances, a processor device 401 can include a deterministic processor device. A deterministic processor device can include, for example, a processor device configured to perform a plurality of operations according to a predetermined order, such as a predetermined program order defined by a compiler. In some instances, a deterministic processor device can include a processor device configured to perform a plurality of operations according to a predetermined timing or according to a predetermined temporal relationship between operations. For example, in some instances, a deterministic processor can include a processor configured to receive one or more computer-executable instructions (e.g., compiled instructions, etc.) comprising timing data; and execute the instruction(s) according to a predetermined time or predetermined temporal relationship indicated by the timing data. Timing data can include, for example, one or more of: data indicative of a clock cycle on which to execute a particular operation; data indicative of a temporal relationship between one or more first operations and one or more second operations, such as data indicative of a number of clock cycles to pause after a first operation (e.g., data transfer operation, instruction transfer operation, floating-point operation, etc.) is completed before performing a second operation (e.g., floating-point operation, tensor processing operation, etc.); data indicative of one or more operations or instructions configured to have an effect on a timing of operations, such as data indicative of one or more no-operation (NOP) operations or sleep operations, such as a repeated-NOP instruction to cause a functional unit 402 or other component of a processor device 401 to remain idle for a predetermined number of clock cycles; or other timing data.

In some instances, a deterministic processor device can include a processor device configured to receive, from a compiler, a set of computer-executable instructions controlling a timing of a plurality of operations associated with the computer-executable instructions; and perform the plurality of operations according to the timing. For example, in some instances, a deterministic processor device can include a processor device configured to receive a compiled program configured to cause, for each respective operation of a plurality of operations (e.g., arithmetic operations such as floating-point operations, tensor operations, etc.) to be performed on one or more respective data operands (e.g., numerical operands such as machine-learned model parameters, activation values, etc.), an instruction associated with the respective operation to intersect with the respective data operand at a predetermined time instant (e.g., clock cycle, clock cycle offset relative to an initial clock cycle, etc.) defined in the compiled program. In some instances, a deterministic processor can include a processor device having one or more components (e.g., functional unit(s) 402, communication unit(s) 403, etc.) having an instruction set architecture comprising instructions to control a timing of one or more operations of the one or more components.

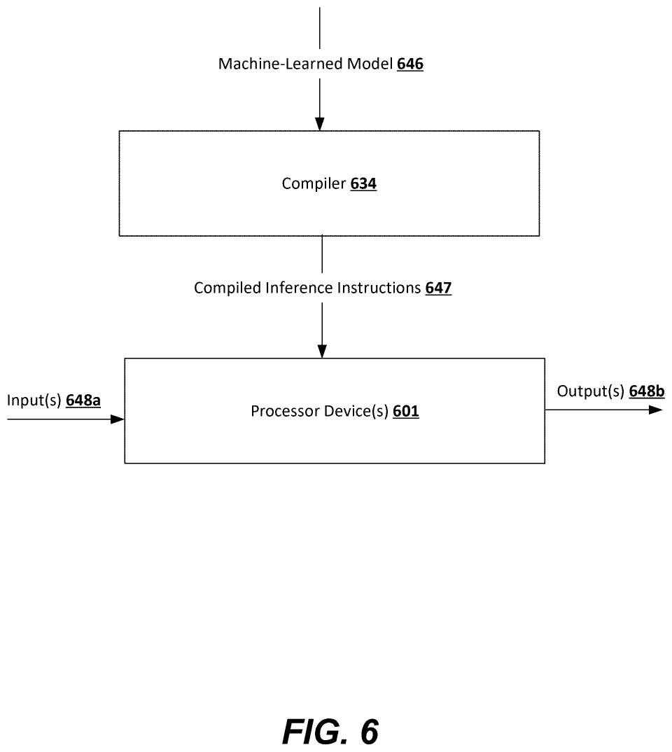

In some instances, a deterministic processor device 401 can include a processor device configured to route data between functional units 402 of the processor device 401 according to a predetermined timing, predetermined routing or pathing, or both. For example, in some instances, a deterministic processor device 401 can include a processor device configured to receive compiled instructions comprising data indicative of one or more data transfers operations to be performed according to one or more predetermined routes determined by a compiler, according to one or more predetermined timing values defined by the compiler, or both. In this manner, for instance, a deterministic processor device 401 can enable a compiler to perform compile-time load balancing for a plurality of data paths, and can execute a plurality of runtime data transfers according to the compile-time load balancing. Further details of an example compiler configured to perform compile-time load balancing are provided below with respect to FIG. 6.

In some instances, a deterministic processor device 401 can include a processor that lacks one or more non-deterministic components that may be commonplace among non-deterministic processor devices, such as branch prediction units, tiered or hierarchical cache devices, runtime load balancing, or other sources of runtime non-determinism (e.g., non-deterministic timing of operations, non-deterministic choice of operations such as non-deterministic routing of data, etc.). For example, in some instances, a processor device 401 can lack any branch prediction components, and can be configured to execute every operation of a compiled program according to a predetermined program order. As another example, in some instances, one or more memory functional units 407 can lack a cache hierarchy or lack any non-deterministic memory component(s). For example, in some instances, one or more memory functional units 407 can be configured to operate deterministically, such as according to a predetermined timing defined by a compiler. For example, in some instances, one or more memory functional units 407 can be configured to perform one or more read operations at one or more times predetermined by a compiler; perform one or more write operations at one or more times predetermined by the compiler; perform one or more refresh operations at one or more times predetermined by the compiler, such that the compiler can have explicit control over a refresh timing of the memory functional unit(s) 407; or the like. For example, in some instances, the compiler can compile a program or other executable into a set of deterministic operations that can be executed by the functional unit(s) 402 at known times specified by a deterministic schedule.

However, although a deterministic processor device 401 can lack some common sources of non-determinism, in some instances, a deterministic processor device 401 can include or interact with one or more non-deterministic components or devices without deviating from the scope of the present disclosure. As a non-limiting illustrative example, in some instances, a deterministic processor device 401 can include a PCIe 413 component configured to perform external input/output (I/O) operations, which can in some instances include input/output operations having a non-deterministic timing (e.g., I/O operations using a non-deterministic PCIe 413 device; I/O operations receiving input from non-deterministic external device(s); etc.). In some instances, a deterministic processor device 401 can interact with non-deterministic component(s) or device(s) (e.g. components or devices internal or external to the processor, etc.), while maintaining deterministic operation of the remaining components of the processor device 401 by designating one or more predetermined time windows to interact with the non-deterministic component(s) in a deterministic manner. For example, in some instances, a processor device 401 can be configured to check, at each of a plurality of predetermined times, whether one or more inputs (e.g., inference request(s), etc.) has been received via a PCIe device 413; and, if the processor device 401 determines that an input has been received, to process the input (e.g., write the input to a designated memory location or region, etc.) according to a predetermined timing or predetermined set of instructions (e.g., according to a set of operations configured to fit within a predetermined time window reserved for non-deterministic external I/O operations, etc.).

In some instances, a processor device 401 can include a processor device configured for single-instruction multiple-data (SIMD) operation. For example, in some instances, a processor device 401 can be configured to receive one or more computer-executable instructions that are each indicative of an operation to be performed on a plurality of operands, such as a vector of numerical operands; a tensor of numerical operands; or the like. In some instances, a SIMD processor device can include a processor device configured to provide a single instruction to a plurality of functional units 402 (e.g., adjacent functional units 402 arranged in a functional region, etc.) to cause each respective functional unit 402 of the plurality of functional units 402 to execute the instruction on one or more distinct operands provided to the respective functional unit 402 (e.g., routed to the respective functional unit 402 according to a predetermined compiler-defined routing, etc.).

In some instances, a processor device 401 can include a single-core processor device, or a processor device configured to operate as a single-core device (e.g., flexible-operation processor device having two hemispheres that can be operated in series as a single-core device or in parallel as a multi-core device, etc.). For example, in some instances, a single-core processor device can include a processor device configured to receive a single set of instructions (e.g., compiled instructions, etc.) and to execute, in a serial or pipelined fashion using one or more functional units 402, a set of operations defined by the single set of instructions. For example, in some instances, a single-core processor device 401 can include a processor device configured to obtain (e.g., receive, retrieve, etc.) one or more instructions (e.g., SIMD instructions, etc.) indicative of a plurality of operations (e.g., plurality of SIMD operations, etc.) to be performed on one or more operands; and perform, in series using a plurality of functional units 402, the plurality of operations (e.g., SIMD operations wherein each operation is a multiple-data operation, etc.) on the one or more operands.

Functional unit(s) 402 can include, for example, one or more components (e.g., integrated circuit components, etc.) configured to perform operations on one or more operands (e.g., data operands, etc.). In some instances, functional unit(s) 402 can include deterministic functional units 402, such as deterministic functional units configured to perform one or more operations in a predetermined program order, according to a predetermined timing or temporal relationship, or the like. In some instances, a set of functional units 402 can include a plurality of dedicated or special-purpose functional units 402, such as distinct functional units 402 having distinct functions or sets of functions (e.g., limited or specialized function sets, etc.). In some instances, functional unit(s) 402 can include functional units configured to perform multiple operations per instruction for at least some instructions, such as single-instruction multiple-data (SIMD) functional unit(s) 402, and/or functional unit(s) 402 configured to process instruction(s) directed to multiple computing operations (e.g., multiple repetitions of a single type of operation, pipeline of multiple different operations, etc.).

In some instances, a set of dedicated functional unit(s) 402 can include distinct dedicated functional units 402 for each of a plurality of steps in a machine-learned inference pipeline, such as a distinct dedicated functional unit for each component of a category or type of machine-learned model layer (e.g., convolutional layer, attention layer, fully connected layer, etc.). For example, in some instances, a set of dedicated functional units 402 for implementing a fully connected layer of a machine-learned model can include one or more matrix functional units 409 for performing matrix multiplication between a parameter tensor (e.g., weight matrix, etc.) and a tensor (e.g., vector, etc.) of input values to the fully connected layer, and one or more vector functional units 410 for performing an activation function of the fully connected layer. As another example, in some instances, a set of dedicated functional units 402 for implementing a convolutional layer of a machine-learned model can include one or more permute/routing functional units 411 configured to perform one or more data reshaping operations corresponding to one or more convolutions (e.g., two-dimensional convolutions, one-dimensional convolutions, etc.); and one or more other functional units 402 (e.g., matrix functional unit(s) 409, vector functional unit(s) 410, etc.) for performing additional operations associated with a convolutional layer or convolutional neural network (e.g., matrix multiplication, pooling, activation functions, etc.).

In some instances, a plurality of dedicated functional units 402 can include a first functional unit 402 configured to perform a set of operations that is different (e.g., completely disjoint from or partially overlapping, etc.) from a second set of operations associated with a second functional unit 402. In some instances, a plurality of special-purpose or dedicated functional units 402 can have a plurality of distinct instruction set architectures, such as limited or special-purpose instruction set architectures each supporting a limited or special-purpose set of operations. As a non-limiting illustrative example, in some instances, a set of dedicated functional units 402 can include one or more of: a matrix functional unit 409 configured to perform a first set of matrix operations (e.g., matrix multiplication operations, etc.); a vector functional unit 410 configured to perform a set of vector operations different from the matrix operations (e.g., activation function operations such as rectified linear unit (ReLU), sigmoidal, softmax, or other activation function operations; normalization operations; etc.); a permute/routing functional unit 411 configured to perform one or more data routing, data permutation, or data reshaping functions (e.g., tensor permutation or reshaping, etc.) different from the matrix operation(s) and different from the vector operation(s); or other dedicated functional unit(s) 402. Other examples are possible.

In some instances, functional unit(s) 402 can include functional units organized into functional regions of a processor die, such as compact functional regions configured to facilitate low-latency propagation of instructions or operands within a functional unit 402 or between adjacent functional units 402. As a non-limiting illustrative example, in some instances, one or more functional units 402 can be organized into functional slices along a first axis of a processor die, thereby enabling low-latency propagation of one or more instructions along the axis, low-latency propagation of operand data along a second axis, or the like.

In some instances, functional unit(s) 402 or functional region(s) can be geographically organized on a processor die to reduce (e.g., minimize or nearly minimize; reduce relative to a random arrangement or relative to a conventional multi-core central processing unit or conventional graphics processing unit, etc.) a communication cost (e.g., latency cost, power cost, communication distance, etc.) associated with one or more computational pipelines, such as machine-learned inference pipelines. For example, in some instances, one or more functional units 402 or functional regions of a processor device 401 for performing a sequentially first operation in a computational pipeline can be geographically close to one or more functional units 402 for performing a sequentially second operation in the computational pipeline. Example computational pipelines can include, for example, inference pipelines associated with common machine-learned model, layer, or head architectures, such as convolutional architectures; attention architectures; fully connected layer architectures; selective structured state space machine architectures; gating architectures (e.g., long short-term memory, etc.); or another machine learning architecture.

In some instances, functional unit(s) 402 can include functional units configured to perform multiple operations per instruction for at least some instructions, such as single-instruction multiple-data (SIMD) functional unit(s) 402 or functional units 402 configured to operate without necessarily receiving explicit instructions for each operation. For example, functional unit(s) 402 configured to operate without necessarily receiving explicit instructions for each operation can include one or more of: functional unit(s) 402 configured to receive intermittent instructions and perform multiple operations per instruction (e.g., repeated single operation, pipeline of multiple different operations, etc.); functional unit(s) 402 configured to operate without instructions according to a default operation; or the like. In this manner, for instance, an amount of communication required to provide instructions to the functional units 402 can be reduced, and operation of the processor device 401 can in some instances be simplified compared to some alternative implementations.

For example, in some instances, a SIMD functional unit 402 can include a tensor functional unit 408 configured to execute an instruction on a plurality of numerical values, such as a vector or matrix of numerical values. For example, in some instances, a tensor functional unit 408 can be configured to receive an instruction; and process, according to the instruction, a tensor (e.g., one-dimensional vector tensor, two-dimensional matrix tensor, etc.) comprising a plurality of numerical values (e.g., dozens of numerical values per instruction, such as hundreds, such as 320 numerical values in some examples). In some instances, a tensor functional unit 408 can be configured to process some or all of a plurality of values simultaneously, or to execute a single-instruction multiple-data instruction according to a staggered timing (e.g., according to example implementations described below).

As another example, in some instances, a functional unit 402 configured to operate based on intermittent instructions can include a functional unit 402 configured to repeat one or more operations, such as a functional unit 402 configured to continue performing a given operation (e.g., an operation associated with a most recently received instruction, etc.) periodically (e.g., at every clock cycle; at every Nth clock cycle; etc.) for some amount of time (e.g., indefinitely, for a finite period of time such as a time period defined by a previously received instruction, etc.) in the absence of explicit instructions. In some instances, a functional unit 402 can include a functional unit 402 configured to receive and execute one or more repetition instructions (e.g., having an instruction set architecture comprising one or more repetition instructions, etc.). A repetition instruction can include, for example, an instruction to cause the functional unit 402 to repeat (e.g., repeat at every clock cycle; at every Nth clock cycle, where N can be a parameter of the instruction; etc.) a previous instruction or set of instructions a number of times specified by the instruction; an instruction indicative of an operation to be repeated (e.g., arithmetic operation, matrix operation, vector operation, etc.), the instruction having a repetition parameter indicating a number of times to repeat the operation; or the like. In some instances, a repetition instruction can include one or more offset parameters, such as a time offset parameter (e.g., number of cycles to wait between repetitions, etc.), location offset parameter indicative of a distance between consecutive locations (e.g., functional unit 402 location, memory location, data path location, etc.) associated with a repeated operation, or other offset parameter.

As another example, in some instances, a functional unit 402 can include a functional unit 402 configured to receive a single instruction indicative of multiple distinct operations to be performed on a single operand or set of operands, such as a multiply-accumulate (MACC) instruction or matrix multiplication instruction indicative of one or more multiply operations and one or more accumulate operations to be performed on one or more outputs of the multiply operation(s). In some instances, a functional unit 402 can include a pipelined hardware architecture (e.g., systolic array pipelined hardware, deterministic streaming hardware such as hardware having one or more properties described herein, etc.) configured to provide (e.g., directly; indirectly via one or more buffers, registers, or other memory components; etc.) an output of one or more first hardware devices (e.g., floating-point units, etc.) for performing earlier (e.g., sequentially first, etc.) operations of a multi-operation instruction to an input of one or more second hardware devices for performing later (e.g., sequentially second or last, etc.) operations of the multi-operation instruction. In some instances, a pipelined hardware architecture of a functional unit 402 can include a geographically compact architecture, wherein a plurality of components for performing a multi-operation instruction can be adjacent or otherwise close together on a processor die.

An arithmetic functional unit 406 can include, for example, one or more functional units 402 for performing various arithmetic operations, such as floating-point operations, integer operations, or quantized operations; simple operations (e.g., add, multiply, format conversion, etc.) or complex/combined operations (e.g., multiply-accumulate, etc.); single-operand operations or multi-operand operations (e.g., tensor operations, etc.); or other arithmetic operations. In some instances, an arithmetic functional unit 406 can be a tensor functional unit 408 or component thereof, or have one or more properties described below with respect to tensor functional unit(s) 408.

A memory functional unit 407 can include, for example, one or more functional units 402 for reading, writing, or storing various kinds of data, such as operand data, instruction data, or other data. Data storage can include, for example, temporary storage of one-time-use or ephemeral values (e.g., computed operand values, etc.), longer-term storage of values to be reused (e.g., machine-learned model weights, compiled computer-executable instructions, etc.), or other storage. In some instances, a memory functional unit 407 can include one or more low-latency, high-bandwidth, or otherwise rapidly accessible memory devices, such as random access memory (RAM) devices (e.g., static random access memory (SRAM), high-bandwidth memory (HBM), dynamic random access memory (DRAM), etc.), registers, or other low-latency devices.

In some instances, one or more memory functional units 407 can be configured to share a global address space accessible to a plurality of functional units 402. For example, in some instances, a global address space can include all memory locations available to the processor device 401 (e.g., including any external memory modules, etc.), such that any functional unit 402 of the processor device 401 can obtain (e.g., receive at a predetermined time defined by the compiler, such as without requiring the functional unit 402 to output any request for the data obtained). In some instances, a set of memory functional unit(s) 407 can include, or a processor device 401 can have access to, one or more internal (e.g., on-chip) memory functional units 407; one or more external (e.g., off-chip, near-compute, etc.) memory units; or both.

A tensor processing unit 408 can include, for example, a functional unit 402 to perform one or more operations (e.g., arithmetic operations such as tensor multiplication, elementwise multiplication, normalization, activation function operations, etc.) on one or more tensors (e.g., matrices, vectors, etc.). In some instances, a tensor processing unit 408 can include a matrix functional unit 409; a vector functional unit 410; or another functional unit.

A matrix processing unit 409 can include, for example, a functional unit 402 configured to perform one or more operations on a matrix (e.g., two-dimensional matrix, flattened matrix, etc.) of operands (e.g., numerical values such as floating-point values, etc.). In some instances, a matrix processing unit 409 can include a functional unit 402 configured to perform matrix multiplication or other matrix operations.

A vector processing unit 410 can include, for example, a functional unit 402 configured to perform one or more operations on a vector (e.g., one-dimensional vector, flattened tensor, etc.) of operands (e.g., floating-point numerical values, etc.). In some instances, a vector processing unit 410 can include a functional unit 402 configured to perform one or more of: one or more activation function operations (e.g., sigmoidal or logistic activation function, linear unit activation function such as rectified linear unit (ReLU), softmax activation function, etc.), one or more normalization operations (e.g., L2 normalization, etc.), one or more combining operations (e.g., attention-based combining, etc.) to combine a set (e.g., pair, trio, etc.) of vectors, one or more constituent operations configured to be combined to support a class of related operations (e.g., class or category of normalization operations, class or category of activation function operations, etc.), or the like.

A permute/routing functional unit 411 can include, for example, a functional unit 402 configured to perform one or more data permuting or data routing operations. In some instances, a data permuting operation can include one or more swap or reordering operations configured to reorder data in an ordered format (e.g., vector format or other tensor format; ordered arrangement of registers, signal lines, or other hardware units; etc.), such as without changing a shape (e.g., length, width, number of dimensions, etc.) of the ordered format. Example reordering operations can include, for example, rotation or translation operations; arbitrary reordering operations defined by one or more reordering maps such as a gather map; or other reordering operations. In some instances, a data permuting operation can include a reshaping operation, such as a reshaping operation changing a number of dimensions of a data structure (e.g., tensor, hardware devices corresponding to a tensor, etc.), changing a size of one or more dimensions of the data structure, or the like. As a non-limiting illustrative example, in some instances, a reshaping operation can include a tensor flattening operation to convert a multi-dimensional tensor into a one-dimensional data structure (e.g., vector, hardware configuration corresponding to a vector, one-dimensional data stream corresponding to a vector, etc.). As another example, in some instances, a reshaping operation can include an expansion or duplication operation, such as a reshaping operation to generate an expanded convolutional kernel to implement a filter component of a convolutional neural network. In some instances, a routing operation can include a permuting operation to change an ordering of operands input to one or more fixed or predetermined data paths, or another routing operation (e.g., switching operation; pair of operations comprising a send and a receive; etc.). In some instances, a permuting operation can include a routing operation to change a routing of operands to hardware having a fixed or predetermined input order.

In some instances, a memory functional unit 407; a tensor, matrix, or vector functional unit 408, 409, 410; or a permute/routing functional unit 411 can be or include a deterministic functional unit 402 configured to execute instruction(s) at a predetermined time defined by a compiler; a single-instruction multiple-operation functional unit 402 configured to perform a plurality of operations based on one instruction; or have any other property described herein with respect to functional unit(s) 402.

Communication units 403 can include various components for performing communication operations (e.g., input, output, etc.) between the processor device 401 and other devices (e.g., processor devices, computing devices, external memory devices, etc.) or components, or within the processor device 401. In some instances, communication units 403 can include deterministic communication units (e.g., communication units performing operations according to a predetermined program order, timing, temporal relationship, or other predetermined property, etc.), non-deterministic communication units (e.g., communication units having non-deterministic timing properties, communication units configured to communicate with non-deterministic external devices, etc.), or both. For example, in some instances, a deterministic processor device 401 can include a plurality of deterministic chip-to-chip communication links 412 configured to communicate with other deterministic processor devices 401 (e.g., using deterministic communication operations having a predetermined timing, communication path, or other property), along with one or more PCIe components 413 configured to interact with one or more non-deterministic components. In some instances, communication units 403 can include or have access to various components, such as serializer-deserializer (SerDes) units configured to serialize data to be output or deserialize data received as input; communication ports, connections, interface units, or the like; communication lines (e.g., electrically conductive signal traces, electrically conductive wires, optical fibers, cables, etc.); routing or data permutation components (e.g., internal routing or permutation components such as switching components; external components coupled to the processor device 401 such as routers, repeaters, switches, panels, or the like); or other components configured to facilitate one or more communication operations.

Chip-to-chip communication units 412 can include, for example, any device or component for communicating with another processor device (e.g., processor device 401, etc.), such as one or more serializer-deserializer units, one or more communication channels (e.g., signal lines, etc.), one or more connection components (e.g., ports, pins, connection pads, etc.), or the like. In some instances, a processor 401 can include a plurality of chip-to-chip communication ports to facilitate direct communication with a plurality (e.g., four, eight, sixteen, etc.) of other chips, such as according to a high-radix chip-to-chip communication topology (e.g., dragonfly topology, hyperX topology, etc.), such as a topology having greater than or equal to eight chip-to-chip communication links per processor device 401. In some instances, chip-to-chip communication units 412 can include units configured to communicate with processor devices that are geographically close to or far away from the processor device 401 (e.g., in a same or different compute node as the processor device 401; in a same or different rack; etc.). In some instances, chip-to-chip communication units 412 can include connections to a plurality of distinct chips, a plurality of connections to a single chip, or both. In some instances, chip-to-chip communication units 412 can include chip-to-chip communication units 412 associated with one or more bidirectional communication channels, one or more unidirectional communication channels, or both. In some instances, chip-to-chip communication units 412 can include deterministic communication units configured to perform chip-to-chip communication operations (e.g., send operation, receive operation, etc.) at one or more times predetermined by a compiler; deterministic communication units having a known or deterministic timing for one or more data transfer operations; or the like. In some instances, one or more timing units 405 can be used to provide synchronization for one or more processor devices 401 to facilitate deterministic-timing communication between chips.

A peripheral component interconnect express (PCIe) component 413 can include, for example, a communication device configured to facilitate communication between a processor device 401 and one or more other devices (e.g., computing devices; processor devices; data storage devices; auxiliary devices; etc.). In some instances, a PCIe unit 413 can include a communication system conforming to one or more PCIe communication standards (e.g., PCIe 6.0, PCIe 7.0, etc.). Although FIG. 4 depicts a PCIe unit 413, other communication units or communication standards can be used without deviating from the scope of the present disclosure. In some instances, a processor device 401 can include a deterministic processor device 401 configured to communicate non-deterministically via the PCIe unit 413 while maintaining determinism in the functional unit(s) 402 of the processor device 401 (e.g., according to methods described above).

In some instances, control unit(s) 404 can include one or more devices for controlling one or more operations of the functional unit(s) 402, such as device(s) configured to supply one or more control signals (e.g., assembly code or machine code instructions; switching signals, multiplexer selection signals, etc.) to one or more functional unit(s) 402.

In some instances, control unit(s) 404 can include one or more instruction control unit(s) 414 configured to supply computer-executable instruction(s) to one or more functional units. In some instances, an instruction control unit 414 can include a deterministic instruction control unit 414 configured to supply instruction(s) to the functional unit(s) 402 according to a predefined program order determined by the compiler; supply instruction(s) at one or more predefined times (e.g., clock cycles, etc.); or the like. In some instances, an instruction control unit 414 can include hardware configured to fetch (e.g., prefetch, etc.) instruction(s) from memory at a first time (e.g., before the instructions are needed; during a time of off-peak memory usage; at a time predetermined by a compiler; etc.) and provide corresponding instruction(s) to one or more functional unit(s) 402 at a second time (e.g., second time predetermined by the compiler, etc.)

In some instances, instruction(s) provided to a functional unit 402 by an instruction control unit 414 can be the same as or different from a corresponding instruction received by the instruction control unit 414. For example, in some instances, an instruction control unit 414 can include a unit configured to translate one or more compiled instructions (e.g., instructions in a first computing language or format output by a compiler, etc.) to one or more control signals (e.g., instructions in a second language or format; other control signals such as multiplexer selection signals or the like). In some instances, translating compiled instructions can include translating a memory-efficient stored instruction to a plurality of control signals that may include a greater data volume than the memory-efficient stored instruction. For example, in some instances, translating compiled instructions can include retrieving, from a memory functional unit 407, a compiled instruction; and providing, based on the compiled instruction, a plurality of control signals to one or more (e.g., a plurality of) functional units 402 over one or more (e.g., a plurality of) clock cycles. In some instances, a memory-efficient stored instruction can include a multi-operation instruction associated with a plurality of related operations (e.g., operations of a machine-learned model layer such as matrix multiplication, activation functions, convolution, attention, or the like), and the translated control signals can include a plurality of control signals (e.g., lower-level instructions, etc.) for executing the multi-operation instruction. In some instances, an instruction control unit 414 can include hardware configured to receive an instruction comprising one or more timing parameters (e.g., delay amounts, etc.) or repetition parameters, and output control signal(s) to the functional unit(s) 402 to cause the functional units to perform operations according to the timing or repetition parameters (e.g., at a predetermined clock cycle defined by a compiler, etc.). In some instances, the instruction control unit 414 can control a timing or a number of repetitions of the functional unit(s) 402 by sending control signals comprising timing or repetition data, or by sending raw control signals at a specific time or plurality of times configured to cause the functional unit(s) 402 to perform operations according to one or more timing or repetition parameters.

In some instances, timing and synchronization units 405 can include various components configured to perform synchronization operations, such as operations to track or communicate time data (e.g., current clock cycle data, etc.) to one or more functional units 402 or other components of a processor device 401. In some instances, timing and synchronization units 405 can include one or more of: one or more hardware-aligned counters 415, one or more software-aligned counters 416, or other timing or synchronization component.

Hardware aligned counters 415 may be used to establish a time base for electronic circuitry in each system, such as a clock, for example. Additionally, each system may include software aligned counters 416. Software aligned counters 416 may be synchronized, for example, based on one or more computer-executable instructions (e.g., compiled instructions determined by a compiler, etc.). Hardware aligned counters 415 and software aligned counters 416 may be implemented as digital counter circuits, for example, on each integrated circuit (e.g., each processor device 401 or each die thereof, etc.). For instance, hardware aligned counters 415 may be free-running digital counters (e.g., 8-bit counters) on a processor device 401 that are synchronized periodically. Similarly, software aligned counters 416 may be digital counters (e.g., 8-bit counters) that are synchronized based on timing markers triggered by one or more compiled programs.

In some instances, timing and synchronization units 405 can include one or more components 405 for internal synchronization of a plurality of components (e.g., functional units 402, etc.) of a processor device 401; one or more components 405 for external synchronization between a first processor device 401 and one or more other devices (e.g., a plurality of second processor devices 401, etc.); or both.

In some instances, synchronizing a first device (e.g., first processor device 401 or another device) with a second device (e.g., second processor device 401 or another device, etc.) can include, for example, synchronizing one or more hardware aligned counters 415 of the first processor device 401 with one or more hardware aligned counters of the second device. Synchronizing the hardware aligned counters 415 may occur periodically during the operation of each system and may occur at a higher frequency than synchronizing software counters 416, for example. Synchronizing hardware counters may include the first device sending a timing reference (e.g., timing bits representing a time stamp) to the second device over a communication channel (e.g., via chip-to-chip communication units 412, etc.). In some instances, a first system may send an 8-bit time stamp, for example. In such a scenario, a hardware counter 415 and software counter 416 of the first device may be maintained in sync locally. However, as the hardware counter 415 on a second device is synchronized to the hardware counter 415 on a second device, the software counter 416 on the second device may drift.

In some instances, software aligned counters 416 of a pair of devices can be synchronized by providing, in each of the devices (e.g., as part of a compiled program executed by the devices, etc.), one or more timing markers configured to be sequentially triggered (e.g., at predetermined positions in a compiled program corresponding to particular points of time or particular cycles). In some instances, timing markers in each device may be configured to trigger on the same cycle in each system. For example, a first program on a first device may trigger a timing marker on the same cycle as a second program on a second device when the devices' hardware aligned counters 415 are synchronized. In some instances, these timing markers may be used to synchronize software counters 416 of both devices. For example, in some instances, timing differences between the timing markers may correspond to a time difference indicative of a degree to which the two devices are out of synchronization, and synchronization can include adjusting a timing of one or more operations based on the time difference. For example, in some instances, a software aligned counter 416 can perform one or more delay operations at each of a plurality of timing markers, and a length of the delay can be adjusted based at least in part on a time difference between the first and second device at the timing marker. However, same-cycle timing is not required; for example, in some instances, a pair of timing markers may be offset by a known number of cycles, which may be compensated for during the synchronization process (e.g., by using different fixed delays, etc.).

In some instances, a timing difference (e.g., number of cycles, etc.) between timing markers may be constrained within a range. For example, a minimum time difference between timing markers in a first and second device may be based on a time to communicate information between the devices (e.g., a number of cycles greater than a message latency), and a maximum time difference between timing markers in the devices may be based on a tolerance of oscillators forming the time base on each system (e.g., if the time difference increases beyond a threshold for a given time base tolerance, it may become more difficult or impossible for the systems to synchronize for a given fixed delay). The minimum and maximum number of cycles may also be based on the size of a buffer (e.g., a first in first out (FIFO) memory) in each chip-to-chip communication circuit, for example.

In some instances, synchronizing hardware aligned counters 415 of a pair of devices can include sending, by a first device at a first time t0, a timing reference; and receiving, at a second time t1 by a second device, the timing reference. In some instances, the latency of such a transmission may be characterized and designed to be a known time delay Δt=t_1−t_0. In such instances, synchronizing the pair of devices can include setting, by the second device, a hardware aligned counter 415 to a value of (t0+Δt) such that the hardware aligned counters 415 of both devices are synchronized.

In some instances, although the first and second devices can be architecturally similar (e.g., same) or different, synchronizing the devices can include, for example, assigning a first device as a designated sender device to send timing data, and designating a second device as a designated receiver device to receive timing data and adjust a timing of the receiver device's operations based on the timing data.

In some instances, software aligned counters 416 can be synchronized in a manner similar to synchronization of hardware aligned counters 415. For example, in some instances, a software aligned counter 415 can include or implement one or more timing triggers comprising one or more delays (e.g., no-operation (NOP) delays, etc.), wherein a plurality of devices are configured to perform a synchronized delay, such that one or more operations performed after the synchronized delay may be synchronized. For example, in some instances, a first device may send timing data to a second device at t0; and perform a predefined delay operation until t1. A second device may receive the timing data at (t0+Δt); and determine, based on the timing data, an amount of delay (e.g., number of clock cycles, etc.) to cause the second device to resume operations at t1.

In some instances, synchronization can include fine synchronization (e.g., as described above), coarse synchronization, or both. For example, during various points in operation, the first and second systems may be far out of sync. For example, during startup or after a restart (collectively, a “reset”), a set (e.g., pair, etc.) of devices may perform a coarse synchronization (e.g., using a 20-bit digital counter, etc.) to bring the time bases close enough so they can be maintained in alignment using the techniques described above (e.g., within a resolution of the hardware and software counters, such as 8 bits).

In some instances, synchronizing a number of devices greater than two can include performing similar operations with more than two devices, such as pairwise synchronizations at staggered times, such as pairwise synchronization of a processor device 401 with each of a plurality of neighbors in a chip-to-chip communication topology at a plurality of respective times; one-to-many (e.g., one-to-all, etc.) broadcasting of timing data; pairwise propagation of timing data between pairs of devices according to a propagation pattern or communication topology; or other mechanism for sending and receiving timing data and updating a timing of operations based on the timing data.

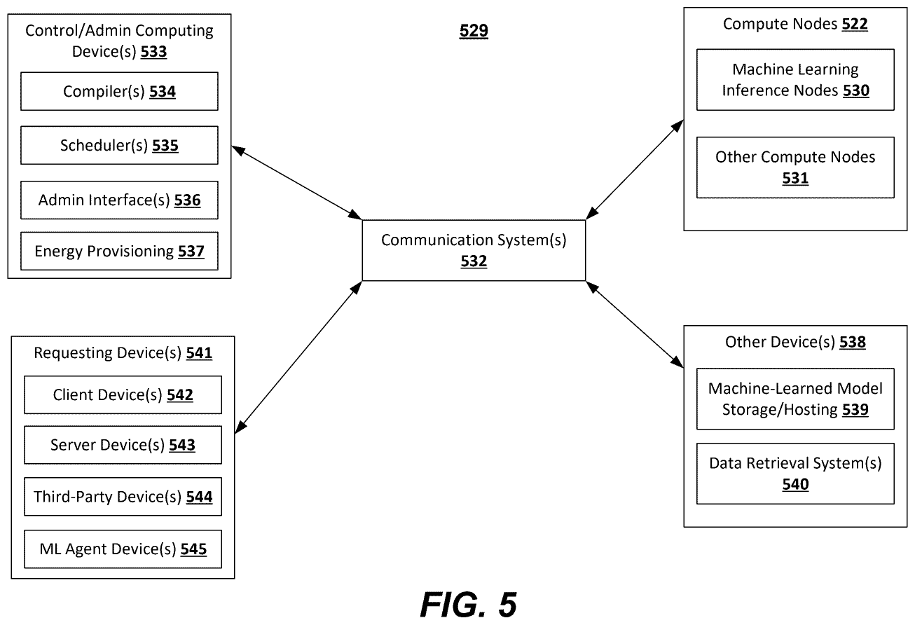

FIG. 5 is a block diagram of an example multi-node computing system 529 according to example implementations of aspects of the present disclosure. The computing system can include, for example, a plurality of compute nodes 522 (e.g., machine learning inference nodes 530, other compute nodes 531, etc.) in communication with one or more other devices via one or more communication systems 532. For example, in some instances, the computing system 529 can include one or more control or administration devices 533 configured to provide control functions for the compute nodes 522, such as control or administration devices 533 comprising one or more compilers 534 configured to generate compiled computer-executable instructions to be provided to the compute nodes 522; one or more scheduler(s) 535 configured to schedule one or more operations (e.g., machine learning inference operations) to be performed by the compute nodes 522; one or more administrative interfaces 536 configured to enable human control over the compute nodes 522 or control/admin device(s) 533; or one or more energy provisioning components 537 configured to manage or allocate an energy (e.g., electricity, etc.) supply or energy usage for one or more computing operations. In some instances, the computing system 529 can include one or more other devices 538, such as one or more machine-learned model storage or hosting devices 539 configured to store machine-learned model data (e.g., parameter data, compiled computer-executable instruction data, etc.), one or more data retrieval systems 540 configured for storage and retrieval of other data (e.g., context data for retrieval-augmented generation, etc.), or other devices 538. In some instances, the compute nodes 522 or control/admin nodes 533 can be in communication, via the communication system(s) 532, with one or more requesting devices 541, such as client device(s) 542, server device(s) 543, third-party device(s) 544, machine-learned agent device(s) 545, or other requesting device(s) 541. Responsive to receiving one or more requests (e.g., machine-learned inference requests, etc.) from one or more requesting devices 541, the computing system 529 can cause the compute nodes 522 to perform one or more operations to satisfy the request(s).

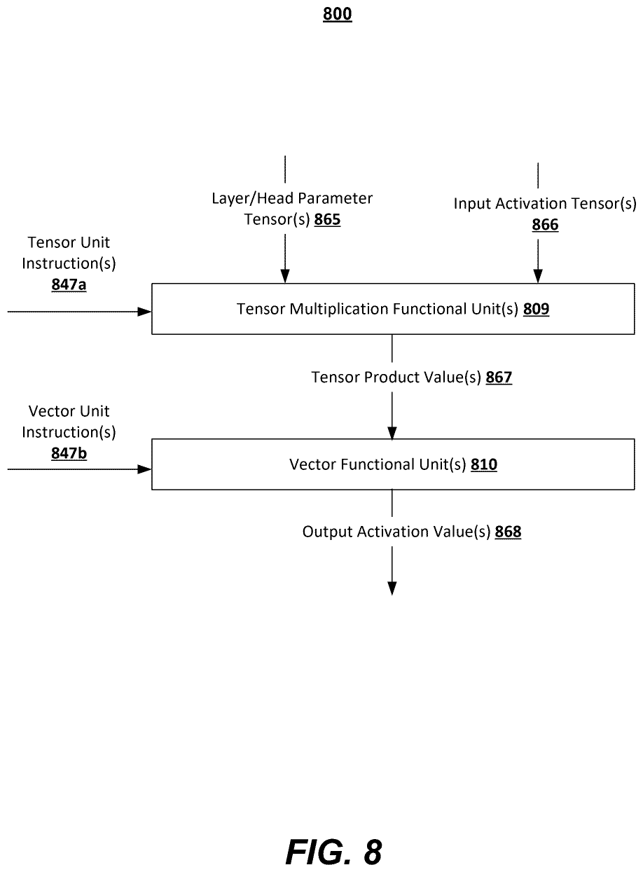

Machine learning inference nodes 530 can include, for example, compute nodes 522 that are configured or adapted (e.g., optimized or nearly optimized, etc.) to perform one or more machine learning inference tasks; compute nodes 522 that are designated or scheduled to perform one or more machine learning inference tasks; or the like. For example, in some instances, a machine learning inference node 530 can have one or more processors adapted to machine learning inference tasks, such as processor having one or more properties described herein with respect to processors devices 401. In some instances, a machine learning inference task can include one or more operations described below with respect to FIG. 8.

Machine learning inference nodes 531 can include, for example, compute nodes 522 that may not be configured or scheduled for performing machine learning inference tasks, such as compute nodes that are scheduled for performing various non-machine-learning tasks, such as cloud computing tasks, software-as-a-service tasks, support tasks to support one or more machine learning inference nodes, interface hosting or other application hosting, computation tasks (e.g., scientific computation, etc.), data storage or retrieval tasks, or other computing tasks.

A communication system 532 can include, for example, any system configured to provide communication between compute nodes 522 and other devices, such as a communication network (e.g., Ethernet network, internet network, local area network, etc.), one or more direct (e.g., non-networked, etc.) communication links, or other communication system or device. In some instances, a communication system can include one or more devices or components described herein with respect to communication units 403, communication channel(s), or other communication components.

A control or administration device 533 can include, for example, any device (e.g., computing system, etc.) configured to provide one or more control or administration functions to control an operation of one or more compute nodes 522 (e.g., machine learning inference nodes 530, etc.). For example, in some instances, a control/admin computing device 533 can include one or more compilers 534 or schedulers 535 configured to control or schedule one or more operations (e.g., machine-learned inference operations, etc.) of a compute node 522; one or more control functions configured to control various properties (e.g., topology, etc.) of a computing system comprising one or more compute nodes 522; one or more administrator interfaces 536 configured to enable an administrator (e.g., human administrator, computer-implemented administrator process, etc.) to select one or more configuration options or control options (e.g., scheduling options, compilation options, etc.); or other control or administration functions (e.g., energy provisioning 537 functions, etc.).

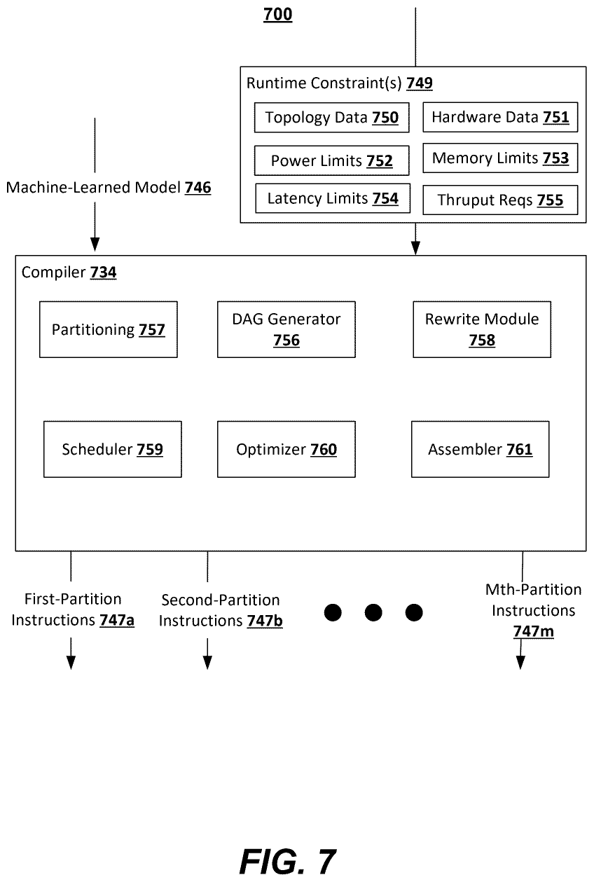

A compiler 534 can include, for example, a device or process (e.g., process executing on a computing system, etc.) configured to receive data indicative of one or more computing operations (e.g., machine-learned inference operations, etc.) and generate, based at least in part on the data indicative of the one or more computing operations, a set of compiled computer-executable instructions for performing the one or more computing operations. In some instances, a compiler 534 can include a compiler configured to control a timing of one or more computational operations (e.g., temporal relationship between operations, etc.), such as a compiler configured to control a timing of one or more deterministic operations performed by one or more deterministic processor devices. Further details of some example compilers are provided below with respect to FIGS. 6-7.

A scheduler 535 can include, for example, a device or process (e.g., process executing on a computing system, etc.) configured to receive data indicative of one or more computing operations (e.g., machine-learned inference operations associated with machine-learned inference requests received from requesting devices 541, etc.) and determine a schedule for performing the computing operations. For example, in some instances, a scheduler 535 can allocate the operation(s) to one or more compute nodes 522; determine a time (e.g., immediately; according to an ordering of operations such as immediately after an earlier-scheduled operation is completed; at a selected time of day, such as a time of off-peak demand; etc.) or other criterion (e.g., threshold number of available compute nodes 522; priority level of other scheduled computing operations; etc.) for beginning the one or more computing operations; or other scheduling activity. In some instances, scheduling can include determining a number of compute nodes 522 to perform a given computing operation. In some instances, scheduling can include selecting between a plurality of precompiled sets of compiled instructions for performing a given set of computing operation(s), and causing a set of compute node(s) 522 to execute the selected set of compiled instructions. For example, in some instances, a machine-learned model can be compiled a plurality of times to generate a plurality of precompiled sets of instructions for performing inference with the machine-learned model, such as precompiled sets for performing inference with different numbers of available compute nodes 522; with different restrictions on latency, power usage, memory usage, or other runtime constraints; or the like. Further details of an example system for compiling different sets of instructions based on different runtime constraints are provided below with respect to FIG. 7.

An administrator interface 536 can include, for example, any interface (e.g., user interface such as graphical user interface, application programming interface, etc.) for receiving data indicative of one or more administrative actions or administrative selections, such as configuration option selections (e.g., topology configuration, runtime constraint configuration, etc.), operation scheduling selections (e.g., maintenance operation scheduling, inference request scheduling, etc.), or other administrative selections.

An energy provisioning component 537 can include, for example, a process or device configured to allocate or provision energy (e.g., electricity, power, etc.) to one or more compute nodes 522. In some instances, an energy provisioning component 537 can include one or more power source components, energy storage devices, power regulator devices, or other energy provisioning components. In some instances, an energy provisioning component 537 can include a power regulator component configured to receive demand data indicative of an amount of power needed (a “demand load”) by one or more load devices at one or more times; and control, based at least in part on the demand data, one or more properties of a supply of power provided to one or more load devices.

In some instances, an energy provisioning component 537 can include one or more components for determining (e.g., measuring, predicting, estimating, etc.) one or more present or future demand load values, such as a present wattage, expected peak wattage, expected total number of watt hours, or other measure of power demand over a period of time. In some instances, determining one or more future demand load values can include predicting near-term demand load values or long-term demand load values, such as an expected peak demand value or expected cumulative demand value over a time period comprising seconds, minutes, hours, days, or another time period. In some instances, measuring a future demand load (e.g., near-term future demand load, etc.) can include obtaining first data indicative of a plurality of compute operations (e.g., already-scheduled inference jobs, etc.); obtaining second data indicative of an amount of power used by each compute operation (e.g., based on measured power usage data, hardware data, etc.); and determining, based on the first and second data, a future demand load associated with a given time or time period. In some instances, data indicative of an amount of power used by a job can include, for example, hardware data indicative of an amount of power that one or more devices (e.g., processor device(s) 401, etc.) use for each of one or more hardware operations (e.g., hardware operations defined by a compiled instruction set, etc.); instruction data correlating each of one or more compute jobs to a plurality of instructions or operations included in the compute job(s); or other power data. In some instances, predicting a future demand load can include obtaining time series data indicative of past demand loads; and predicting (e.g., using a machine-learned model; using a non-machine-learned algorithm; etc.), based on the time series data, on or more future load values.

In some instances, an energy provisioning component 537 can include one or more components configured to perform one or more control actions (e.g., energy provisioning adjustments, compute job scheduling adjustments, etc.) based on measured or predicted demand data. In some instances, a control action can include determining or adjusting a schedule of one or more compute jobs, such as determining a time at which a compute job should be performed; allocating one or more devices to the compute job; or other scheduling determination. In some instances, a control action can include determining or adjusting a set of compiled instructions for executing one or more compute operations, such as selecting between a plurality of compiled instruction sets configured to perform a given compute operation with different power usage profiles (e.g., different power usage profiles and different performance characteristics, such as latency characteristics, etc.) In some instances, a control action can include determining or adjusting an energy provisioning schedule, such as increasing or decreasing an amount of power routed to one or more devices (e.g., energy storage devices, processor devices 401, compute nodes, etc.); causing an energy storage device to transmit or receive power; or other energy provisioning action. In some instances, a control action can be based on one or more of short-term (e.g., seconds, minutes, etc.) and long-term (e.g., hours, days, etc.) power prediction data. For example, in some instances, a control action can include an action to control an amount of power routed to an energy storage device during an off-peak period based at least in part on an amount of power drawn or predicted to be drawn from the energy storage device during an earlier or later peak-usage period.

Other devices 538 can include, for example, any other device (e.g., computing device, storage device, etc.) configured to interact with compute node(s) 522, such as machine-learned model storage/hosting device(s) 539 configured to store compiled or uncompiled machine-learned model data and provide the machine-learned model to other devices (e.g., control/admin devices 533, compute nodes 522, client devices 542, etc.), data retrieval system(s) 540 such as systems storing retrievable context data for retrieval-augmented inference operations (e.g., retrieval-augmented generation, etc.) or the like.

A requesting device 541 can include, for example, any device configured to transmit one or more computation requests (e.g., inference requests, etc.) to one or more of: one or more compute nodes 522, one or more control/admin computing devices 533, or other destination. In some instances, a requesting device 541 can include a computing device (e.g., computing device comprising one or more processors, memory components, storage components, input/output components, communication components, or the like), communication device (e.g., interface device configured to transmit a request from a user or from another device, etc.), or the like.

A client device 542 can include, for example, a device associated with a client (e.g., end user, etc.) who may originate an inference request, or who may originate another request or action (e.g., search query, question, chatbot interaction, etc.) that may trigger an inference request (e.g., server-originated inference request, machine-learned agent-originated inference request, etc.). In some instances, a client device can be a computing device, such as a laptop, smart phone, smart glasses, augmented reality headset, gaming console, tablet, desktop, workstation, or other computing device.

A server device 543 can include, for example, a computing device configured to interact with one or more client devices 542, third-party devices 544, or machine-learned agent devices 545 (e.g., via a network such as the internet). For example, in some instances, a server device 543 can receive, from one or more client devices 542, third-party devices 544, or machine-learned agent devices 545, a machine-learned inference request identifying an inference operation to be performed, or the server device 543 can receive another input (e.g., search query, question, chatbot interaction, etc.) and determine, based on the other input, one or more machine-learned inference operations to be performed. The server device 543 can then provide, for example, an inference request to one or more of: one or more compute nodes 522, one or more control/admin devices 533 (e.g., a scheduler 535, etc.), or the like.

A third-party device 544 can include, for example, a computing device (e.g., Linux server, etc.) associated with a third party different from a client or end user and different from an operator of the compute nodes 522.

A machine-learned agent device 545 can include, for example, a device operating a machine-learned agent configured to output data indicative of one or more inference requests. For example, in some instances, a machine-learned agent can include an agent configured to output one or more natural language inference requests; one or more application programming interface (API) calls or other computer-executable instructions indicative of an inference request; or more specialized tokens indicative of an inference request; or the like. In some instances, a machine-learned agent can include an agent configured to receive an input (e.g., user query, task request, inference request, etc.); and perform a plurality of action selection iterations based on the input (e.g., to perform a requested task or answer a provided question, etc.). For example, a first action selection iteration can include selecting, based on the input, a first action to be performed (e.g., by the machine-learned agent or by another device or process); and obtaining first data indicative of a result of the performed action. A second action iteration can then include selecting, by the machine-learned agent based on the first data indicative of the result of the first action, a second action to be performed; and obtaining second data indicative of a result of the second action. This can be repeated for a plurality of iterations (e.g., indefinitely) until the machine-learned agent selects an ending action (e.g., outputting a final output to an end user, etc.). In some instances, a machine-learned agent device 545 can include a device having a machine-learned agent configured to select an action from an action space that includes one or more inference request actions to submit an inference request to the compute nodes 522. In some instances, a machine-learned agent device 545 can include a third-party device 544 operated by a different entity (e.g., organization, etc.) compared to the compute nodes 522, or can be a device (e.g., machine-learned inference node 530, etc.) operated by an entity that is the same as an entity controlling the compute nodes 522.

FIG. 6 is a block diagram of an example system 600 for compiling a machine-learned model according to example implementations of aspects of the present disclosure. A compiler 634 can obtain (e.g., receive, retrieve, etc.) data indicative of a machine-learned model 646. The compiler 634 can generate, based on the data indicative of the machine-learned model 646, one or more compiled inference instructions 647 configured to cause one or more processor devices 601 to perform one or more operations (e.g., inference operations, etc.) using the machine-learned model 646. The compiler 634 can provide the compiled inference instructions 647 to the processor device(s) 601, and the processor device(s) 601 can execute the compiled inference instructions 647 based at least in part on one or more inputs 648a to generate one or more outputs 648b (e.g., machine-learned inference outputs generated using the machine-learned model 646, etc.).

In some instances, a processor device 601 can be, comprise, be comprised by, or otherwise share one or more properties with a processor device 401. For example, in some instances, a processor device 601 can have any property described herein with respect to a processor device 401, and vice versa.

In some instances, a compiler 634 can be, comprise, be comprised by, or otherwise share one or more properties with a compiler 534. For example, in some instances, a compiler 634 can have any property described herein with respect to a compiler 534, and vice versa.

In some instances, a compiler 634 can include a compiler configured to generate compiled inference instructions for one or more deterministic processor devices 601. For example, in some instances, a compiler 634 can include a compiler configured to control a timing of one or more (e.g., all, etc.) operations of one or more processor devices 601 to perform inference using the machine-learned model 646. In some instances, a compiler 634 can obtain (e.g., receive, retrieve from memory or storage, etc.) hardware knowledge indicative of various known properties of one or more compilation target processor devices 601, such as data indicative of a number, type, and location of each of a plurality of components (e.g., functional unit(s) 402, communication links 403, etc.) of the target processor device(s) 601; data indicative of an amount of time (e.g., number of clock cycles, etc.) that one or more operations may take to complete; or other timing data. In some instances, data indicative of an amount of time an operation may take can include, for example, data indicative of a number of clock cycles a functional unit 402 may take to perform a functional operation; data indicative of a transit time (e.g., number of clock cycles, etc.) for an operand data item to be transmitted from a first component (e.g., functional unit 402, communication unit 403, etc.) to a second component or from a first processor device 601 to a second processor device 601; data indicative of a transit time for instruction data to be transmitted from an instruction control unit 414 to a functional unit 402; or other timing data.

In some instances, a compiler 634 can be configured to schedule, based on the timing data, a plurality of operations (e.g., data transfer operations, functional unit 402 operations, instruction transfer operations, etc.) to cause one or more operands to intersect with one or more instructions at a functional unit 402 for executing the instructions on the operand(s) at a predetermined time instant (e.g., absolute or relative clock cycle value, etc.) selected by the compiler 634. In some instances, a compiler 634 can be configured to identify one or more data dependencies (e.g., operations that may receive, as input, an output of a previous operation, etc.) or other prerequisites to one or more operations; and deterministically schedule, based on timing data, a dependent operation at a time when all dependencies of the dependent operation will be satisfied. In some instances, a compiler 634 can control a timing of various operations of various processor 601 components (e.g., functional units 402, communication units 403, control unit(s) 404, etc.) in various ways, such as by controlling an order of operations; using one or more delay instructions to cause a processor 601 to remain idle until a predetermined time for performing a next operation; or the like. A delay instruction can include, for example, a no-operation instruction to perform no operation for one or more clock cycles; an instruction having a delay parameter indicative of a number of clock cycles to wait before or after executing the instruction; or other delay instruction.

In some instances, scheduling one or more operations can include scheduling based at least in part on dependency data. For example, in some instances, a compiler 634 can identify one or more dependencies (e.g., prerequisite operations, required operand data, etc.) of an operation; determine a completion time at which each dependency will be satisfied; and schedule the dependent operation based on the expected completion time(s). As another example, in some instances, a compiler 634 can identify a scheduled time at which a dependent operation will be performed, and schedule a start time of one or more prerequisite operations based on the scheduled time and data indicative of a duration of each prerequisite operation. As another example, in some instances, a compiler 634 can identify a periodicity (e.g., number of clock cycles per operation or set of operations) of a set of repeated operations (e.g., repeated prerequisite operations, etc.) and schedule a related set of repeated operations (e.g., repeated dependent operations, etc.) based on the periodicity (e.g., by scheduling an amount of delay between iterations of the related set of repeated operations, etc.).

In some instances, a duration of one or more operations can include a sum of a one or more time costs (e.g., duration, latency, etc.) of the one or more operations, such as one or more of: a duration or latency of one or more functional operations (e.g., floating-point operations, memory access operations, etc.) of one or more functional units 402; a duration or latency of one or more data transfer operations transferring an output of a prerequisite operation to a functional unit 402 scheduled to perform a dependent operation; or other time cost values. In some instances, scheduling a dependent operation can include determining an expected end time of one or more prerequisite operations (e.g., start time plus duration, etc.); and providing a delay instruction to a functional unit 402 performing the dependent operation to cause the functional unit 402 to execute after any dependencies are satisfied. In some instances, scheduling a prerequisite operation can include determining a latest permissible start time of one or more prerequisite operations (e.g., dependent-operation start time minus prerequisite-operation duration, etc.); and causing the prerequisite operation to be initiated on or before the latest permissible start time. In some instances, scheduling a plurality of operations can include scheduling a plurality of prerequisite operations to cause a plurality of prerequisites to be satisfied simultaneously (e.g., such that a plurality of operands intersect at a given functional unit 402 at a time determined by the compiler 634, etc.), such as by delaying one or more of the prerequisite operations to synchronize the operations with a latest-finishing prerequisite operation, or the like.

In some instances, a compiler 634 can be configured to schedule one or more operations, or allocate one or more operations to component(s) (e.g., functional units 402, etc.) for performing the operations, based at least in part on one or more of: an expected latency, an expected level of concurrency, an expected throughput, or other expected performance measure associated with one or more allocations. For example, in some instances, a compiler 634 can perform one or more memory allocation operations to reduce a latency, increase a level of memory concurrency, or otherwise improve a performance of one or more operations. For example, in some instances, a compiler 634 can identify a plurality of operand values (e.g., machine-learned model 646 parameters, etc.) to be used concurrently (e.g., parameters belonging to the same layer or head of a machine-learned mode 646, etc.), and can allocate the plurality of operand values to a plurality of independently accessible memory banks to increase memory concurrency, reduce latency, or otherwise improve performance of a processor device 601.

In some instances, a compiler 634 can be configured to deterministically schedule a timing of one or more communication operations or data access operations, such as memory access, chip-to-chip communication operations between two or more processor devices 601, or the like. For example, in some instances, a compiler can obtain hardware knowledge indicative of a topology of a chip-to-chip communication network; obtain (e.g., receive, retrieve, generate, etc.) data indicative of one or more data transfers to be performed; and allocate one or more communication links 403 for performing the data transfer(s). In some instances, the hardware data can include timing data (e.g., any form of timing data described above, etc.), and the compiler 634 can control a timing of the data transfer(s) based on the timing data. In some instances, scheduling one or more data transfers can include compile-time routing or compile-time load balancing. For example, in some instances, a compiler 634 can determine, at compile time, an amount of data associated with a data transfer; and determine, based on the amount of data and a bandwidth of one or more communication links 403, an amount of time required to transmit the data over the communication link(s) 403. In some instances, the compiler 634 can determine, based on the timing data, a reduced-latency set of data transfer path(s) for transferring the data, and can allocate the data transfer operation to the reduced-latency path(s). For example, in some instances, the compiler 634 can determine that performing a large data transfer over a small number of minimal data transfer paths (e.g., data transfer paths with a minimal number of hops, minimal latency for a one-byte transfer, etc.) may take a long time due to low collective bandwidth of the minimal data transfer paths; and allocate, at compile time, one or more non-minimal data transfer paths to the data transfer (e.g., in addition to one or more minimal paths, etc.). In some instances, a compiler 634 can control, based on the timing data, a timing of one or more data transfer operations, such as by controlling a timing of one or more memory accesses to cause a plurality of transferred data items to arrive simultaneously or near-simultaneously (e.g., with a reduced gap between first and last data of a given data transfer or set of concurrent operands, etc.).

A machine-learned model 646 can include, for example, various kinds of machine-learned model architectures, such as architectures having one or more feedforward layers (e.g., fully connected layers, perceptron layers, etc.), attention layers, convolutional layers, recurrent layers, gating components, structured state space machine layers, or other components. In some instances, a machine-learned model 646 can include a machine-learned model configured to generate various kinds of outputs, such as classification outputs, generative outputs (e.g., generative language outputs such as natural language or computer code, generative image outputs, video outputs, audio outputs, text outputs, multimodal outputs, etc.), predictive outputs, or other output type. In some instances, a machine-learned model 646 can be configured to process various input types, such as language, numerical, text, audio, video, image, time series data, or other input type. In some instances, a machine-learned model 646 can include one or more nodes, each node comprising one or mor parametrized operations, each parametrized operation comprising one or more operators and one or more operand parameters.

In some instances, data indicative of a machine-learned model 646 can include various kinds of data, such as source code data (e.g., TensorFlow source code data, PyTorch source code data, etc.), parameter data (e.g., .safetensors file comprising a plurality of parameter tensors, etc.), operator data, or other data indicative of a machine-learned model 646.

Operators of a parametrized operation can include, for example, arithmetic operators, matrix transformation operators, Boolean operators, and other operators which take one or more inputs and generate a single output (i.e., functions), including any operators used within a machine learning model on input data. Further examples of specific operators may include multiplication, division, convolution, projection, matrix multiplication, activation functions (e.g., softmax, ReLU, sigmoid, etc.), combination operators (e.g., elementwise addition, pooling, etc.), and so on.

In some instances, parameters of a machine-learned model 646 can include tensor(s) comprising a plurality of parameter values. Parameter values can include, for example, operands for one or more operations of the machine-learned model 646 (e.g., operations taking both parameter value(s) and input value(s) as operands, etc.). Parameter values can include, for example, operands that are trained during a training process of the machine-learned model 646.

Compiled inference instruction(s) 647 can include, for example, a set of computer-executable instructions (e.g., assembly code, machine code, object code, compiled binary, etc.) configured to cause one or more processor devices 601 to perform inference using the machine-learned model 646. In some instances, compiled inference instruction(s) 647 can include instructions in a format recognized by one or more instruction control units 414 of the processor device(s) 601; one or more functional units 402 of the processor device(s) 601; or both.

Inputs and outputs 648a, b can include, for example, various kinds of data, such as numerical data, text data, language data, image data, audio data, video data, multimodal data, or other data type. In some instances, inputs 648a can include inputs provided by a user or other entity (e.g., machine-learned agent, etc.) as part of an inference request. In some instances, outputs 648b can include outputs generated by the machine-learned model 646 based on the inputs 648a.

FIG. 7 is a block diagram of an example system 700 for compiling a machine-learned model according to example implementations of aspects of the present disclosure. A compiler 734 can obtain data indicative of a machine-learned model 746 and one or more runtime constraints 749 for the executing the machine-learned model 746. Based on the machine-learned model 746 and runtime constraints 749, the compiler 734 can partition operations of the machine-learned model 746 into a plurality of partitions. The compiler 734 can generate, for each partition of the plurality of partitions, a set of compiled inference instructions 747a, b, . . . m, (referred to collectively as compiled inference instructions 747) to cause one or more processor devices to execute operations of the partition according to the runtime constraints.

Runtime constraints 749 can include, for example, data defining various limits for the execution of the machine-learned model 746, as executed on the processor after the machine-learned model 746 is compiled using the compiler 734. For example, in some instances, runtime constraints 749 can include one or more of: topology data 750 indicative of a communication topology associated with a plurality of processors for executing the machine-learned model 746; hardware data 751 indicative of one or more properties of hardware (e.g., processor devices, etc.) for executing machine-learned model 746 operations; limits 752, 753, 754 on an amount of power, memory, time, or other resource to be used in executing machine-learned model 746; performance targets such as throughput requirements 755; or other runtime constraints.

Runtime constraints 749 may be provided, for example, by a vendor, user, or other entity that plans to use the machine-learned model 746. The runtime constraints 749 may include execution time constraints, power usage constraints, thermal constraints (from execution of the model), hardware use constraints, hardware version constraints, and other characteristics of the execution. These constraints may be defined using any type of measurement, and can be a relative measure or a direct value. For example, the execution time constraint may be defined according to time or clock cycles. As another example, the power usage constraints may be defined by total joules, power use per unit time, average power use per unit time, and so on. As another example, the thermal constraints may be defined as total watts dissipated, or by a percentage of the maximum thermal heatsink dissipation available to a particular configuration of a processor. As another example, the hardware use constraints may constrain the execution of the machine-learned model 746 to use only a certain number or percentage of the hardware resources, such as various functional units in the processor, or memory or cache in the processor. After receiving these runtime constraints 749, in one embodiment, the compiler 734 can attempt to generate one or more compiled sets of computer-executable instructions 747 that meet (or fall within) these runtime constraints 749. However, in other embodiments, the compiler 734 does not receive a set of runtime constraints 749. In some instances, the compiler 734 can be instructed to compile different versions of binaries that each optimize for one or more different constraints.

In some instances, a compiler 734 can include a directed acyclic graph (DAG) generator 756, a partitioning module 757, a rewrite module 758, a scheduler 759, a constraint optimizer 760, and an assembler 761.

The DAG generator 756 can receive, for example, data (e.g., parameter data, programming language data such as PyTorch or TensorFlow data, etc.) indicative of a machine-learned model 746 and generate directed acyclic graph (DAG) data indicative of the machine-learned model. A DAG, or directed acyclic graph, is a finite directed graph with no directed cycles (i.e., loops). A DAG can represent, for example, all the dependencies between the outputs of nodes of a machine-learned model 746 and the inputs to other nodes in the machine-learned model 746. In some instances, each vertex (e.g., node) in the DAG may represent an operand of the machine-learned model 746, and each edge in the DAG may represent an operator of the machine-learned model 746. Alternatively, each operand and each operator may each be represented by a separate vertex in the DAG. In this second case, some vertices in the DAG can represent operands, and some can represent an operator as well as its output. As the operands of some operators are themselves outputs from other operators, the DAG shows the relationship between these various operands and operators in the machine-learned model 746.

To generate the DAG, the DAG generator 756 may parse data (e.g., code data, parameter data, etc.) indicative of the machine-learned model 746 to identify operations (e.g., neural network nodes, etc.) or operands (e.g., parameters, such as tensors of parameter values, etc.). The DAG generator 756 may begin by assigning vertices to the inputs of the machine-learned model 746. These inputs feed into nodes of the model 746, and these nodes are assigned their own vertices in the DAG by the DAG generator 756. The outputs of these nodes may be tensors that feed into other nodes, and so the DAG generator 756 may indicate this by directing the vertices of these nodes into other vertices representing the other nodes. This can continue until the entire machine-learned model 746 is parsed by the DAG generator 756. This process may run in linear time.

A partitioning module 757 can, for example, divide the machine-learned model 746 or corresponding DAG into a plurality of partitions, such as a plurality of partitions to be executed by different processor device(s) 401 or groups of processor devices 401. For example, in some instances, a partitioning module 757 can obtain a DAG indicative of a plurality of operations of a machine-learned model 746, along with topology data 750 indicative of a set of processor devices 401 to perform the operations, and the partitioning module 757 can allocate the operations to a plurality of partitions based on the topology data 750. For example, in some instances, the partitioning module 757 can select a number of partitions based on a number of processor devices 401, compute nodes, or the like identified in the topology data 750. As another example, in some instances, the partitioning module 757 can group processor devices 401, compute nodes, or partitions into logical groups based on the topology data 750, such as logical groups configured to reduce (e.g., minimize or nearly minimize; reduce relative to a random assignment, etc.) a communication cost, latency, or other cost of performing the plurality of operations of the machine-learned model 746. In some instances, the partitioning model can update the DAG to generate a partitioned DAG, or output data indicative of the selected partitions in another manner.

The rewrite module 758 of the compiler 734 can “rewrite” or translate the operators in the generated DAG into translated instructions, which are machine instructions that can be executed by processor hardware. Machine instructions can include, for example, machine code or language that can be directly executed in a processor device (e.g., processor 401, etc.). In some instances, a translation can map one node or a group of multiple nodes of a machine-learned model 746 into one executable instruction or a set of multiple instructions. The rewrite module 758 may store the translated instructions separately and/or within the DAG along with their respective operators in the corresponding vertices.

A scheduler 759 can order, distribute, and set an execution timing of the translated instructions from the rewrite module 758 such that the translated instructions are set to execute on a predetermined component group or component type of the processor, in a specific execution order, and at a specific clock cycle. The scheduler 759 can access the DAG and determine a preferred (e.g., optimal or near optimal according to runtime constraints 749, etc.) execution order for each of the translated instructions associated with the various vertices in the DAG (e.g., vertices corresponding to nodes of the machine-learned model 746). The optimal execution order may ensure that instructions are only executed when they are needed and can minimize or nearly minimize any time spent blocking on operands that have not yet been computed.

In some instances, a scheduler 759 can include one or more of an instruction placement module, an instruction schedule module, and a memory allocating module.

An instruction placement module can, for example, reorder translated instructions received from the rewrite module 758 to reduce (e.g., reduce relative to an initial ordering received from the rewrite module 758, etc.) or eliminate any unnecessary dependency-related delays in execution. For example, in some instances, a dependency can include an operation that cannot be performed until an earlier operation is complete, such as an operation whose input corresponds to an output of the earlier operation. Such dependencies can be indicated in the DAG. In some instances, an instruction placement module can order, based on data (e.g., DAG data, etc.) indicative of a plurality of dependencies, a plurality of operations of the machine-learned model 746 such that operations having dependencies are scheduled to performed after (e.g., immediately after, etc.) the relevant dependencies are satisfied, thereby preventing a function unit 402 from having to wait unnecessarily for prerequisite operations to finish execution. An instruction placement module may use various types of methods to order the translated instructions, such as using a SAT instance solver (i.e., a Propositional Satisfiability Problem Solver) to determine an ideal ordering of the translated instructions, or using a greedy algorithm, or any other method that may be used to reduce unnecessary dependency-related delays.

In some instances, an instruction schedule module can determine a timing or relative clock cycle for the execution of each translated instruction (e.g., in tandem with an instruction placement module or based on an ordering determined by the instruction placement module, etc.). For example, in some instances, an instruction schedule module can determine a timing of one or more operations (e.g., data transfer operations, matrix or vector arithmetic operations, etc.) to cause one or more operands and one or more instructions to intersect at a functional unit 402 at a predetermined time instant. In some instances, determining a timing of one or more operations can include determining an amount of time for a functional unit 402 to delay or remain idle after completing a previous operation. In some instances, determining an amount of time to delay can include analyzing, for each dependency associated with an instruction, how many clock cycles are needed for the dependency to be satisfied (e.g., how many clock cycles are required to perform an arithmetic operation; how many clock cycles are needed to transfer an operand from a first functional unit 402 to a second functional unit 402; etc.); and determining, based at least in part on the number of clock cycles, a delay amount. For example, in some instances, an instruction schedule module can add the number of clock cycles to a starting time at which a first operation began executing to identify a time (e.g., clock cycle) at which the dependency will be satisfied. The instruction schedule module can then subtract the clock cycle at which the dependency will be satisfied from a clock cycle at which a functional unit 402 will finish a prior operation to determine a number of clock cycles to delay the functional unit 402. Other methods are possible.

In some instances, a delay value can be included with an instruction as a number of clock cycles to wait before executing the instruction, or a delay may be implemented using one or more NOP (no operation) instructions. In some instances, a delay can be defined in relative terms (e.g., +5 clock cycles) rather than absolute terms (e.g., delay till clock cycle 2038) to avoid issues for loops. As loops may require the same instructions to be executed multiple times, having an absolute delay value may cause a delay value to become inaccurate after a single execution of the loop.

A memory allocating module can determine on which hardware component (e.g., functional unit 402, processor 401 of a plurality of processors, etc.) to execute each translated instruction or a group of translated instructions. In some instances, a memory allocating module may allocate instructions to hardware based at least in part on dependency data, such as by allocating neighboring instructions in a dependency DAG (e.g., immediately adjacent instructions, groups of connected instructions, etc.) to nearby functional units 402 of a single processor device 401 (e.g., same lane or Superlane of a TSP, neighboring functional slices of a TSP, etc.). The memory allocating module may further determine relative memory locations for where operands should be stored and loaded from. These memory locations may be selected by the memory allocating module based on which functional unit 402 is used to execute the instructions.

After ordering, timing, and distributing the translated instructions, the scheduler 759 can output a set of scheduled instructions. These may be used directly by the assembler 761, or may be optimized via the constraint optimizer 760, as described below.

In one embodiment, the compiler 734 includes a constraint optimizer 760 to optimize the scheduled instructions generated by the scheduler 759 according to the runtime constraints 749. For example, where the runtime constraints 749 include a power constraint 752, the constraint optimizer 760 may defer a set of instructions from execution to ensure that the power constraint is met. In some instances, the constraint optimizer 760 can have knowledge of the entire execution path of a set of scheduled instructions because the scheduled instructions can be statically scheduled per clock cycle and component of the processor. For example, the instructions can lack any unknown branching paths or other steps that would create ambiguity as to how the execution of the instructions is to proceed. Due to this knowledge, the constraint optimizer 760 can modify the scheduled instructions such that the execution of these instructions by the processor fits within the runtime constraints 749. This modification of the scheduled instructions may include rescheduling the instructions, deferring execution of instructions, and so on.

A constraint optimizer 760 can include, for example, one or more components configured to measure one or more runtime properties of one or more sets of operations (e.g., initial set of operations received from a scheduler 759, updated set of operations, etc.); one or more components configured to modify the operations to reduce or increase one or more cost or performance metrics; or the like. Example cost or performance metrics (e.g., resource utilization characteristics, etc.) may include latency, clock cycles used, power draw (cumulative, maximum, average, etc.), memory used, data throughput, heat generated, and so on. In some instances, measuring one or more runtime properties can include, for example, comparing a set of operations to a set of known hardware characteristics, such as a known power cost of performing one or more operations; a known latency of one or more operations; or the like. In some instances, measuring one or more runtime properties can include combining a plurality of runtime properties of a plurality of operations, such as summing a plurality of power usage values to generate a total usage value; summing a plurality of latency values to determine a total latency; or the like.

In some instances, a constraint optimizer 760 can compare one or more runtime properties of a set of operations (e.g., initial set of operations, adjusted set of operations, etc.) received from a scheduler 759 to one or more runtime constraint 749 thresholds (e.g., maximum cost, minimum throughput, etc.), and may adjust the operations based on the comparison. For example, in some instances, a constraint optimizer 760 can determine that one or more constraints is not satisfied, and can adjust one or more operations to cause the constraint to be satisfied. As another example, in some instances, a constraint optimizer 760 can attempt to optimize or nearly optimize (e.g., nearly minimize or maximize, etc.) one or more runtime properties (e.g., latency, etc.) without violating one or more runtime constraint 749 thresholds, such as a maximum power usage, minimum throughput, maximum number of processor devices 401 used, or the like. In such instances, a constraint optimizer 760 can modify a set of operations to increase or reduce the runtime property; compare the modified set of operations to one or more runtime constraint 749 thresholds; and accept or reject the modified operations based on the threshold(s). In some instances, a constraint optimizer 760 can be configured to increase or reduce one or more runtime properties (e.g., latency, power cost, weighted score combining a plurality of raw runtime properties, etc.) as much as possible within a given time limit (e.g., limited time window for operating the constraint optimizer 760, etc.); until a target runtime property threshold is reached; or in another manner.

In some instances, a constraint optimizer 760 can output a plurality of sets of modified instructions associated with a plurality of different runtime constraint 749 values. In some instances, generating a plurality of sets of modified instructions for a plurality of runtime constraint 749 values can include separately performing, for each of the plurality of runtime constraint 749 values, an optimization process. In other instances, generating a plurality of sets of modified instructions can include, for example, measuring one or more properties of a plurality of modified instruction sets; comparing the measurements to a plurality of runtime constraint 749 values; and retaining a preferred set of instructions for each of the plurality of runtime constraint 749 values.

In some instances, a constraint optimizer 760 can modify a set of instructions according to a greedy method. For example, a constraint optimizer 760 can identify a measured runtime property that has the largest deviation with a corresponding runtime constraint 749, and can perform any modifications to a current set of instructions and/or configuration options that are designed to adjust that particular runtime property. After each modification, the existing constraints for a currently modified set of scheduled instructions can be measured, and a new largest-deviation runtime constraint 749 can be identified, and so on.

In some instances, a constraint optimizer 760 can modify a set of instructions according to one or more non-greedy methods, such as using a SMT (satisfiability modulo theory) instance solver, a SAT instance solver, or integer linear processing. In the case of the SAT instance solver, the constraint optimizer 760 may require that some constraints of the execution of an initial set of instructions to be fixed to the value of the corresponding runtime constraint 749, and then have the SAT instance solver modify the instructions in order to attempt to find a solution of modified instructions that meets the fixed constraints.

The modifications in both cases above may involve modifying an ordering, timing, distribution (e.g., allocation to individual processor devices 401 or functional units 402, etc.) of operations. The modifications may also include changing the configuration settings of the processor (which may have various modes), such as configuration settings limiting the number of functional units in use, the amount of memory in use, memory timings, clock speed, power savings mode, etc.

In some instances, a constraint optimizer 760 can output a set of modified (e.g., optimized or nearly optimized, etc.) instructions. In some instances, the constraint optimizer 760 can output metadata indicative of one or more measured or estimated runtime properties of the compiled instructions; one or more runtime constraints 749 used to generate the compiled program; or the like.

The assembler 761 can perform a final compilation and packaging of the scheduled instructions to generate one or more sets of computer-executable instructions 747. The assembler 761 may map the scheduled instructions for a particular hardware version of the processor that is being used, and determine the exact component queue to place each instruction into. The assembler 761 may also package the DAG in encrypted format, as well as the actual constraints as constraint metadata for the final set of assembled instructions as generated by the scheduler 759 within the binary. This can allow a user of the computer-executable instructions 747 to know the expected constraints when the computer-executable instructions 747 are executed on the processor, and can also allow the computer-executable instructions 747 to be re-assembled or re-compiled using the encrypted DAG in the event of a hardware version upgrade of the processor which causes incompatibility with the machine instructions in the computer-executable instructions 747.

In some instances, an assembler 761 can include one or more software, firmware, or hardware components for hardware queue distribution, instruction mapping, and packaging (e.g., binary packaging, encrypted source packaging, etc.)

In some instances, an assembler 761 can determine the individual instruction queues to assign to each of a set of instructions received from an optimizer 760, such as in instances where a processor device 401 may have multiple copies of each functional unit 402. For example, in some instances, a scheduler 759 and constraint optimizer 760 can identify a group or type of functional unit 402 for each instruction, and an assembler 761 may identify the exact instruction queue for the exact functional unit 402 for each instruction. Such assignment can be based, for example, on which memory the instruction needs to access (e.g., grouping operations that need access to the same memory together), or may assign instructions by some other method, such as a round robin allocation. In some instances, such assignments can be constrained by one or more runtime constraints 749 to ensure that any benefit gained from the constraint optimizer 760 is not lost. As an example, an instruction may be assigned to a queue only when memory access latency for instructions in that queue match the previously determined memory access latency when the memory access latency was simulated by the constraint optimizer 760 for that instruction.

In some instances, an assembler 761 can map the memory locations of operands in the optimized instructions to actual memory locations in a specific version of the processor 401 that is the compilation target for the compiler 734. For example, in some instances, a read or write instruction output by a constraint optimizer 760 or scheduler 759 may only include relative memory locations, or placeholder indicators of memory locations, and an assembler 761 can allocate a physical memory location for the read or write. Each operand referencing a memory location in the instruction can be assigned its own actual memory location, and the assembler 761 may further keep track of allocated memory locations and those memory locations that have been deallocated due to manual deallocation, operands falling out of scope, or via a garbage collection process. Those memory locations that have been deallocated can subsequently be re-allocated by the assembler 761 for new operands.

In some instances, an assembler 761 can output one or more assembled packages. For example, an assembler can output a binary package comprising a set of assembled instructions, a set of parameters (e.g., weights, etc.) of the machine-learned model 746, constraint metadata, or other values. In some instances, the set of assembled instructions can be provided to a processor 401, which can execute the instructions.

In some instances, an assembler can output a source package comprising source code data, DAG data, or the like (e.g., to enable recompilation of a machine-learned model 746, etc.). For example, in some instances, a source package can include partially processed or partially compiled DAG data, thereby enabling low-cost or low-latency recompilation in instances where recompilation may require only relatively small or low-level changes (e.g., remapping operands to new functional units 402 or memory locations, etc.). In some instances, such a source package can be encrypted, such that a decryption key is needed to view the source code or DAG.

In some instances, a compiler 734 can generate a plurality of sets of assembled instructions based on a single machine-learned model, such as a plurality of sets of assembled instructions associated with different runtime constraints 749. In such instances, a plurality of sets of assembled instructions may share the same set of model parameters (e.g., weights). In such instances, an assembler 761 can in some instances include the weights in each of a plurality of packaged binaries; store the weights in a separate file, wherein each of a plurality of packaged binaries can include a link to the separate weights file; link from a first compiled binary to a second compiled binary comprising the weights; or the like.

After the machine-learned model 746 is compiled into the computer-executable instructions 747 by the compiler 734 as described above, the computer-executable instructions 747 can be transmitted or loaded onto one or more processor devices (e.g., processor devices 401, etc.), which can execute the computer-executable instructions 747.

FIG. 8 is a block diagram of an example system 800 for performing machine-learned inference according to example implementations of aspects of the present disclosure. One or more matrix (or tensor) multiplication functional units 809 can receive one or more layer/head parameter tensors 865 indicative of a plurality of parameters of a current machine-learned model layer, head, or other component currently being executed; one or more input activation tensors 866 indicative of a plurality of input values to the current layer/head; and one or more tensor unit instructions 847a to cause the matrix multiplication functional unit(s) 809 to perform tensor multiplication of the input activation tensor(s) 866 and layer/head parameter tensor(s) 865 to determine one or more tensor product values 867. One or more vector functional units 810 can receive the tensor product values 867 and one or more vector unit instructions 847b to cause the vector functional unit(s) 810 to execute one or more activation functions based on the tensor product values 867 to generate a plurality of output activation values 868 to be provided to a next layer, head, or other component of a machine-learned model being executed.

In some instances, a matrix multiplication functional unit 809 can be, comprise, be comprised by, or otherwise share one or more properties with a matrix functional unit 409. For example, in some instances, a matrix multiplication functional unit 809 can have any property described herein with respect to a matrix functional unit 409, and vice versa.

In some instances, a vector functional unit 810 can be, comprise, be comprised by, or otherwise share one or more properties with a vector functional unit 410. For example, in some instances, a vector functional unit 810 can have any property described herein with respect to a vector functional unit 410, and vice versa.

In some instances, tensor unit instruction(s) 847a or vector unit instruction(s) 847b can be, comprise, be comprised by, or otherwise share one or more properties with compiled inference instructions 647. For example, in some instances, tensor unit instruction(s) 847a or vector unit instruction(s) 847b can have any property described herein with respect to compiled inference instructions 647, and vice versa.

In some instances, tensor unit instruction(s) 847a can include instructions provided to a matrix multiplication functional unit 809 by an instruction control unit 414 based at least in part on one or more compiled inference instructions 647. Similarly, in some instances, vector unit instruction(s) 847b can include instruction(s) provided to a vector functional unit 810 by an instruction control unit 414 based at least in part on one or more compiled inference instructions 647. In some instances, tensor unit instruction(s) 847a can include instruction(s) requesting one or more matrix multiplication operations. In some instances, vector unit instruction(s) 847b can include instruction(s) requesting one or more activation function operations, such as rectified linear unit (ReLU), sigmoidal (e.g., logistic, etc.), softmax, or other activation function operation. In some instances, an instruction 847a, b can include an instruction comprising repetition or timing data, such as an instruction comprising data indicative of a number of clock cycles to wait between operations (e.g., between repetitions of a repeated operation, etc.); data indicative of a number of times to repeat an operation; or the like.

In some instances, layer/head parameter tensor(s) 865 can include one or more parameters of a machine-learned model 646, such as parameters comprising all or part of a layer, head, or other component of the machine-learned model 646. In some instances, layer/head parameter tensor(s) 865 can include tensor data (e.g., two-dimensional matrix data, etc.) comprising a plurality of numerical parameter values, such as floating-point values (e.g., eight-bit, sixteen-bit, 32-bit, four-bit, or another precision of floating-point values, etc.), integer values (e.g., eight-bit, sixteen-bit, 32-bit, four-bit, or another precision of integer values, etc.), quantized values, or other data type.

In some instances, input activation tensor(s) 866 can include one or more inputs to a layer, head, or other component of a machine-learned model 646, such as an output of a tokenizer or other preprocessor; an output of a previous layer or head of the machine-learned model 646; a raw input value included in an inference request; or other input value. In some instances, input activation tensor(s) 866 can include tensor data (e.g., one-dimensional vector data, etc.) comprising a plurality of numerical activation values, such as floating-point values (e.g., eight-bit, sixteen-bit, 32-bit, four-bit, or another precision of floating-point values, etc.), integer values (e.g., eight-bit, sixteen-bit, 32-bit, four-bit, or another precision of integer values, etc.), quantized values, or other data type.

In some instances, layer/head parameter tensor(s) 865 or input activation tensor(s) 866 can include one or more reshaped (e.g., expanded, flattened, etc.) tensors based on one or more raw parameter sets or input activations. For example, in some instances, a machine-learned model 646 can include one or more convolutional layers each comprising one or more convolutional kernels, and machine-learned inference can include one or more reshaping operations to implement a corresponding convolution, such as a kernel expansion operation to generated an expanded convolutional kernel comprising multiple copies (e.g., rotated or permuted copies, unrotated copies, etc.) of the kernel, an input activation reshaping operation (e.g., flattening operation, etc.), or other preprocessing operation.

Tensor product value(s) 867 can include, for example, a tensor product (e.g., matrix product, etc.) of a layer/input parameter tensor 865 and an input activation tensor 866. Output activation value(s) 868 can include, for example, an output of one or more operation(s) performed by the vector functional unit(s) 810 on the tensor product value(s) 867, such as one or more activation function operations (e.g., ReLU, etc.); one or more normalization operations; one or more combining or mixing operations (e.g., attention-based mixing; gate-based mixing; etc.). In some instances, determining one or more output activation value(s) 868 or tensor product value(s) 867 can include performing one or more operations or using one or more systems described herein with respect to FIGS. 4-8.

In an aspect, the present disclosure relates to a method. The method includes obtaining a request. The method includes obtaining, from a draft model, a first plurality of draft tokens based on the request. The method includes determining an error rate associated with the first plurality of draft tokens. The method includes determining a modified context length for the draft model based on the error rate. The method includes configuring the draft model based on the modified context length.

In some implementations, the method further includes generating, by the draft model, a second plurality of draft tokens with the draft model configured based on the modified context length. In some implementations, the method further includes generating an output based on at least the second plurality of draft tokens.

In some implementations, obtaining the request involves obtaining the request from a requestor device. In some implementations, the method further includes providing the output to the requestor device.

In some implementations, determining the error rate associated with the first plurality of draft tokens involves validating the first plurality of draft tokens by a target model.

In some implementations, an initial context length of the draft model is smaller than a context length of the target model.

In some implementations, the draft model is or includes a smaller model than the target model.

In some implementations, the target model is or includes a large language model (LLM).

In some implementations, determining the error rate involves determining a ratio of rejected tokens to validated tokens.

In some implementations, determining the modified context length involves performing a comparison of a current metric to a target metric and determining to modify a present context length of the draft model based on the comparison of the current metric to the target metric.

In some implementations, the target metric is or includes a target overall throughput.

In some implementations, determining the modified context length involves determining to increase or to decrease the context length from a current context length of the draft model.

In some implementations, configuring the draft model based on the modified context length involves adjusting a size of a key-value cache accessed by the draft model.

In some implementations, obtaining the request, obtaining the first plurality of draft tokens, and configuring the draft model based on the modified context length are performed for a single inference task.

In another aspect, the present disclosure relates to a system. The system includes one or more processors and one or more non-transitory, computer-readable media storing instructions that, when implemented, cause the one or more processors to perform operations. The operations include obtaining a request. The operations include obtaining, from a draft model, a first plurality of draft tokens based on the request. The operations include determining an error rate associated with the first plurality of draft tokens. The operations include determining a modified context length for the draft model based on the error rate. The operations include configuring the draft model based on the modified context length.

In some implementations, the operations further include generating, by the draft model, a second plurality of draft tokens with the draft model configured based on the modified context length. In some implementations, the operations further include generating an output based on at least the second plurality of draft tokens.

In some implementations, obtaining the request includes obtaining the request from a requestor device. In some implementations, the operations further include providing the output to the requestor device.

In some implementations, determining the error rate associated with the first plurality of draft tokens involves validating the first plurality of draft tokens by a target model.

In some implementations, determining the error rate involves determining a ratio of rejected tokens to validated tokens.

In some implementations, determining the modified context length involves performing a comparison of a current metric to a target metric and determining to modify a present context length of the draft model based on the comparison of the current metric to the target metric.

In another aspect, the present disclosure relates to one or more non-transitory, computer-readable media storing instructions that, when implemented, cause one or more processors to perform operations. The operations include obtaining a request. The operations include obtaining, from a draft model, a first plurality of draft tokens based on the request. The operations include determining an error rate associated with the first plurality of draft tokens. The operations include determining a modified context length for the draft model based on the error rate. The operations include configuring the draft model based on the modified context length.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A method, comprising:
obtaining a request;
obtaining, from a draft model, a first plurality of draft tokens based on the request;
determining an error rate associated with the first plurality of draft tokens;
determining a modified context length for the draft model based on the error rate; and
configuring the draft model based on the modified context length.

2. The method of claim 1, further comprising:
generating, by the draft model, a second plurality of draft tokens with the draft model configured based on the modified context length; and
generating an output based on at least the second plurality of draft tokens.

3. The method of claim 2, wherein obtaining the request comprises obtaining the request from a requestor device; and
wherein the method further comprises providing the output to the requestor device.

4. The method of claim 1, wherein determining the error rate associated with the first plurality of draft tokens comprises validating the first plurality of draft tokens by a target model.

5. The method of claim 4, wherein an initial context length of the draft model is smaller than a context length of the target model.

6. The method of claim 4, wherein the draft model comprises a smaller model than the target model.

7. The method of claim 4, wherein the target model comprises a large language model (LLM).

8. The method of claim 4, wherein determining the error rate comprises determining a ratio of rejected tokens to validated tokens.

9. The method of claim 1, wherein determining the modified context length comprises performing a comparison of a current metric to a target metric and determining to modify a present context length of the draft model based on the comparison of the current metric to the target metric.

10. The method of claim 9, wherein the target metric comprises a target overall throughput.

11. The method of claim 1, wherein determining the modified context length comprises determining to increase or to decrease the context length from a current context length of the draft model.

12. The method of claim 1, wherein configuring the draft model based on the modified context length comprises adjusting a size of a key-value cache accessed by the draft model.

13. The method of claim 1, wherein obtaining the request, obtaining the first plurality of draft tokens, and configuring the draft model based on the modified context length are performed for a single inference task.

14. A system, comprising:
one or more processors; and
one or more non-transitory, computer-readable media storing instructions that, when implemented, cause the one or more processors to perform operations, the operations comprising:
obtaining a request;
obtaining, from a draft model, a first plurality of draft tokens based on the request;
determining an error rate associated with the first plurality of draft tokens;
determining a modified context length for the draft model based on the error rate; and
configuring the draft model based on the modified context length.

15. The system of claim 14, wherein the operations further comprise
generating, by the draft model, a second plurality of draft tokens with the draft model configured based on the modified context length; and
generating an output based on at least the second plurality of draft tokens.

16. The system of claim 15, wherein obtaining the request comprises obtaining the request from a requestor device; and
wherein the operations further comprise providing the output to the requestor device.

17. The system of claim 14, wherein determining the error rate associated with the first plurality of draft tokens comprises validating the first plurality of draft tokens by a target model.

18. The system of claim 16, wherein determining the error rate comprises determining a ratio of rejected tokens to validated tokens.

19. The system of claim 14, wherein determining the modified context length comprises performing a comparison of a current metric to a target metric and determining to modify a present context length of the draft model based on the comparison of the current metric to the target metric.

20. One or more non-transitory, computer-readable media storing instructions that, when implemented, cause one or more processors to perform operations, the operations comprising:
obtaining a request;
obtaining, from a draft model, a first plurality of draft tokens based on the request;
determining an error rate associated with the first plurality of draft tokens;
determining a modified context length for the draft model based on the error rate; and
configuring the draft model based on the modified context length.
